(19) United States
(12) Patent Application Publication
(10) Pub. No.: US 2014/0324448 A1
(43) Pub. Date: Oct. 30, 2014

(54) BUSINESS ANALYTICS PACKAGE WITH KEY PERFORMANCE INDICATORS FOR HEALTH CARE PROVIDERS

(71) Applicant: ZIRMED,INC., Louisville, KY (US)

(72) Inventors: James Scott Lacy, Shelbyville, KY (US); Douglas R. Fielding, Finchville, KY (US); Eric L. Sinclair, III, Louisville, KY (US); Christopher L. Schremser, New Albany, IN (US); Jennifer A. Cress, Louisville, KY (US)

(73) Assignee: ZIRMED,INC., Louisville, KY (US)

(21) Appl. No.: 14/263,940

(22) Filed: Apr. 28, 2014

Related U.S. Application Data
(60) Provisional application No. 61/816,273, filed on Apr. 26, 2013.

(51) Int. Cl. G06Q 10/06; G06Q 50/22

(52) U.S. Cl. CPC G06Q 10/06393; G06Q 50/22
USPC 705/2

(57) ABSTRACT

A system for comparing parameters of the revenue cycle of a healthcare provider to benchmark values is provided. The system includes a revenue cycle management company which manages the revenue cycles of a plurality of healthcare providers, wherein each of said revenue cycles includes the submission of healthcare claims by one of said healthcare providers to a plurality of healthcare payers, and the receipt of healthcare claim payments and remittance advice from the plurality of healthcare payers in response to the submitted healthcare claims; a database associated with said revenue cycle management company, wherein said database contains data relating to a plurality of parameters of the revenue cycle of each of said plurality of healthcare providers; and a non-transitory, computer readable medium having recorded therein a software program that contains suitable programming instructions. When executed by a data processing apparatus, the programming instructions cause the data processing apparatus to perform a method for (a) deriving from the database a plurality of performance benchmarks, wherein each performance benchmark corresponds to one of said plurality of parameters, and (b) displaying on a display a graphical depiction of the comparison of the value of at least one of said plurality of parameters for the revenue cycle of one of said plurality of healthcare providers to the benchmark corresponding to said parameter.

### CROSS-REFERENCE TO RELATED APPLICATIONS

This application claims the benefit of U.S. Provisional Application No. 61/816,273, filed Apr. 26, 2013, having the same title, and which is incorporated herein by reference in its entirety.

### FIELD OF THE DISCLOSURE

The present disclosure relates generally to healthcare revenue cycle management, and more particularly to an analytics package, service and software solution which may be utilized by healthcare organizations to manage their revenue cycles more effectively and efficiently.

### BACKGROUND OF THE DISCLOSURE

Revenue cycle management, and the inefficiencies attendant to its current implementations, represents a significant cost to healthcare providers. Unpaid and underpaid claims cost the average healthcare practice thousands of dollars in revenue each year. Frequently, the cost of researching denied or zero paid claims, as reflected in staff resource consumption, outweighs the value of resubmitting the claims.

The cost of uncovering other leaks in the revenue cycle, such as issues with specific payers, lags in response or days-to-pay, can be equally as expensive. In addition to the investment in staff resources that resolving these issues would entail, a typical healthcare provider has imperfect information about industry norms. This lack of information complicates the development of best practices. Consequently, these issues often go unresolved, or are addressed in a suboptimal fashion.

### BRIEF DESCRIPTION OF THE DRAWINGS

FIG. 1 is an illustration of the analytics portion of an embodiment of the software solution disclosed herein.

FIG. 2 is a magnified view of the web component of FIG. 1.

FIG. 3 is a magnified view of the dashboard component of FIG. 1.

FIG. 4 is a magnified view of the preview component of FIG. 1.

FIG. 5 is a magnified view of the report center component of FIG. 1.

FIG. 6 is a magnified view of the report range component of FIG. 1.

FIG. 7 is a magnified view of the scheduler component of FIG. 1.

FIG. 8 is an illustration of the manner in which the analytics portion of FIG. 1 may be navigated.

FIG. 9 is an illustration of an analytics summary page for the software solution of FIG. 1 which provides an overview of several key performance indicators (KPIs).

FIG. 10 is an illustration of a page generated by the software solution of FIG. 1 showing a report of $0 paid claims.

FIG. 11 is an illustration of a page generated by the software solution of FIG. 1 showing a report of adjustments by category and code.

FIG. 12 is an illustration of a page generated by the software solution of FIG. 1 showing a report of adjustments by payer and code.

FIG. 13 is an illustration of a page generated by the software solution of FIG. 1 showing a report of at risk by process code and payer.

FIG. 14 is an illustration of a page generated by the software solution of FIG. 1 showing a report of average AR days.

FIG. 15 is an illustration of a page generated by the software solution of FIG. 1 showing a denied claims report.

FIG. 16 is an illustration of a page generated by the software solution of FIG. 1 showing a patient ineligibility summary report.

FIG. 17 is an illustration of a page generated by the software solution of FIG. 1 showing a patient information conflicts report.

FIG. 18 is an illustration of a page generated by the software solution of FIG. 1 showing a patient responsibility report.

FIG. 19 is an illustration of a page generated by the software solution of FIG. 1 showing a payer denials summary report.

FIG. 20 is an illustration of a page generated by the software solution of FIG. 1 showing a payer responsiveness report.

FIG. 21 is an illustration of a page generated by the software solution of FIG. 1 showing a payment posting report.

FIG. 22 is an illustration of a page generated by the software solution of FIG. 1 showing a potential reimbursements report.

FIG. 23 is an illustration of a page generated by the software solution of FIG. 1 showing a practice statistics report.

FIG. 24 is an illustration of a page generated by the software solution of FIG. 1 showing a provider score card report.

FIG. 25 is an illustration of a page generated by the software solution of FIG. 1 showing a reimbursements aging report.

FIG. 26 is an illustration of a page generated by the software solution of FIG. 1 showing a reversals and corrections report.

FIG. 27 is an illustration of a page generated by the software solution of FIG. 1 showing a top reimbursement issues report.

FIG. 28 is an illustration of a page generated by the software solution of FIG. 1 showing an unpaid claims report.

FIG. 29 is an illustration of a page generated by the software solution of FIG. 1 showing a visit code profile report.

FIG. 30 is an illustration of the accounts page of the analytics portion of the software solution of FIG. 1.

FIG. 31 is an illustration of the analytics page of the report center of the analytics portion of the software solution of FIG. 1.

FIG. 32 is a screenshot from the productivity section of the analytics portion of the software solution of FIG. 1.

FIG. 33 is a screenshot of a KPI gallery in the analytics portion of the software solution of FIG. 1.

FIG. 34 is a screenshot showing a pop-up screen launched by selection of the “Average AR Days Trend” report in the KPI gallery of FIG. 33.

FIG. 35 is a screenshot showing a pop-up screen launched by selection of the “Manage KPI Categories” icon in FIG. 33.

FIG. 36 is a screenshot showing a pop-up screen launched by selection of the “Denial Rate” report in the KPI gallery of FIG. 33.

FIG. 37 is an illustration of the report preview section of the report center in the analytics portion of the software solution of FIG. 1.

FIGS. 38-41 are illustrations of the denied claims section of the report center in the analytics portion of the software solution of FIG. 1.

### SUMMARY OF THE DISCLOSURE

In one aspect, a system for comparing parameters of the revenue cycle of a healthcare provider to benchmark values is provided. The system includes a revenue cycle management company which manages the revenue cycles of a plurality of healthcare providers. Each of said revenue cycles includes the submission of healthcare claims by one of said healthcare providers to a plurality of healthcare payers, and the receipt of healthcare claim payments and remittance advice from the plurality of healthcare payers in response to the submitted healthcare claims. The system further comprises a database associated with said revenue cycle management company, wherein said database contains data relating to a plurality of parameters of the revenue cycle of each of said plurality of healthcare providers.

The system also comprises a non-transitory, computer readable medium having recorded therein a software program that contains suitable programming instructions. When executed by a data processing apparatus, the programming instructions cause the data processing apparatus to perform a method for (a) deriving from the database a plurality of performance benchmarks, wherein each performance benchmark corresponds to one of said plurality of parameters, and (b) displaying on a display a graphical depiction of the comparison of the value of at least one of said plurality of parameters for the revenue cycle of one of said plurality of healthcare providers to the benchmark corresponding to said parameter.

In another aspect, a method is provided for assessing the revenue cycle of a healthcare provider. The method comprises (a) providing a database associated with a revenue cycle management company which manages the revenue cycles of a plurality of healthcare providers, wherein each of said revenue cycles includes the submission of healthcare claims by one of said healthcare providers to a plurality of healthcare payers, and the receipt of healthcare claim payments and remittance advice from the plurality of healthcare payers in response to the submitted healthcare claims, and wherein said database contains data relating to a plurality of parameters of the revenue cycle of each of said plurality of healthcare providers; (b) deriving from the database a plurality of performance benchmarks, wherein each performance benchmark corresponds to one of said plurality of parameters; and (c) displaying on a display a graphical depiction of the comparison of the value of at least one of said plurality of parameters for the revenue cycle of one of said plurality of healthcare providers to the benchmark corresponding to said parameter.

### DETAILED DESCRIPTION

It has now been found that the foregoing needs may be addressed with the systems, methodologies and software solutions disclosed herein. These systems, methodologies and software solutions leverage the unique position of a revenue cycle management company (as an entity with exposure to a broad, national cross-section of the healthcare industry, and as an intermediary in the processing of claims and payments) to detect and process unpaid or underpaid claims, to establish industry norms for various facets of healthcare provider revenue cycles, to compare the parameters of the revenue cycle for a specific healthcare provider to these industry norms, and to use the results to develop best practices for the management of the revenue cycle of the healthcare provider.

In a preferred embodiment, the systems disclosed herein are implemented as an intelligent business software solution to help healthcare providers to effectively and efficiently manage their revenue cycles. The software suite utilizes a national database to benchmark the business of a healthcare provider against a variety of key performance indicators (KPIs). These KPIs are designed to reveal areas where the revenue cycle of a healthcare provider can be improved, thus helping the healthcare provider optimize its performance. The software system visually displays key information, provides insight on key areas, identifies potential areas for improvement, provides actionable advice and recommendations for troubleshooting issues, and allows the user to schedule and automate reports.

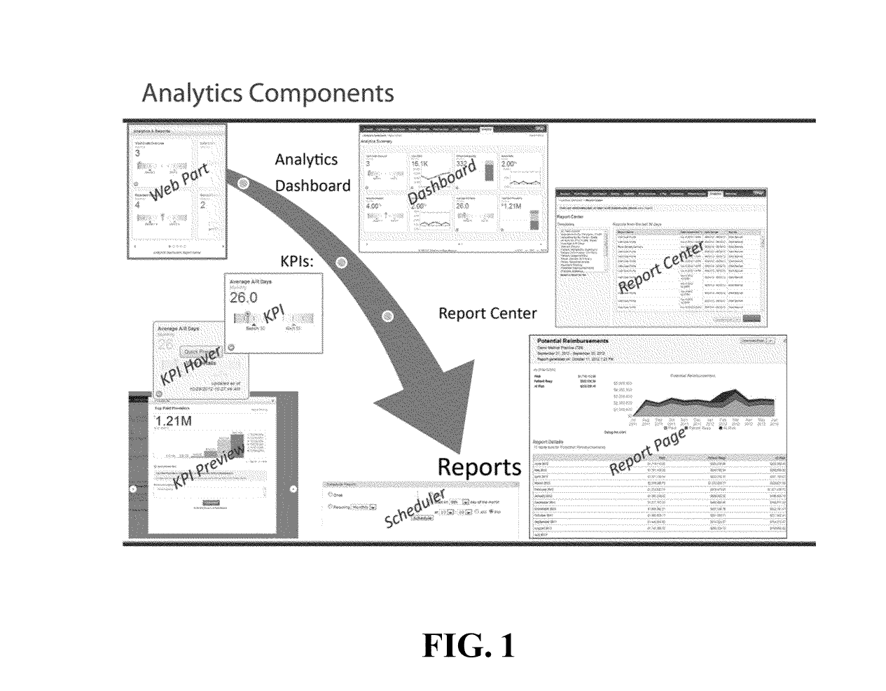

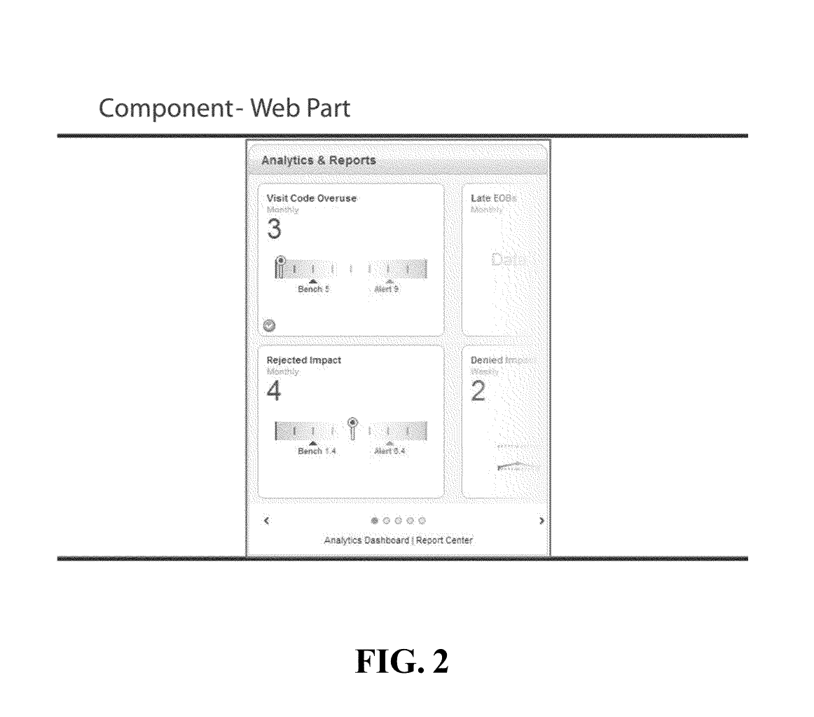

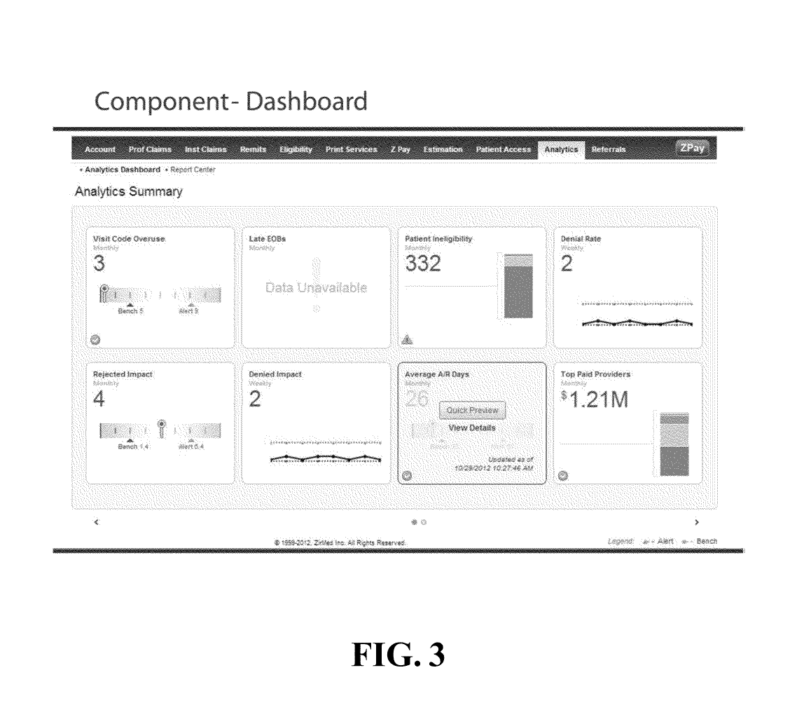

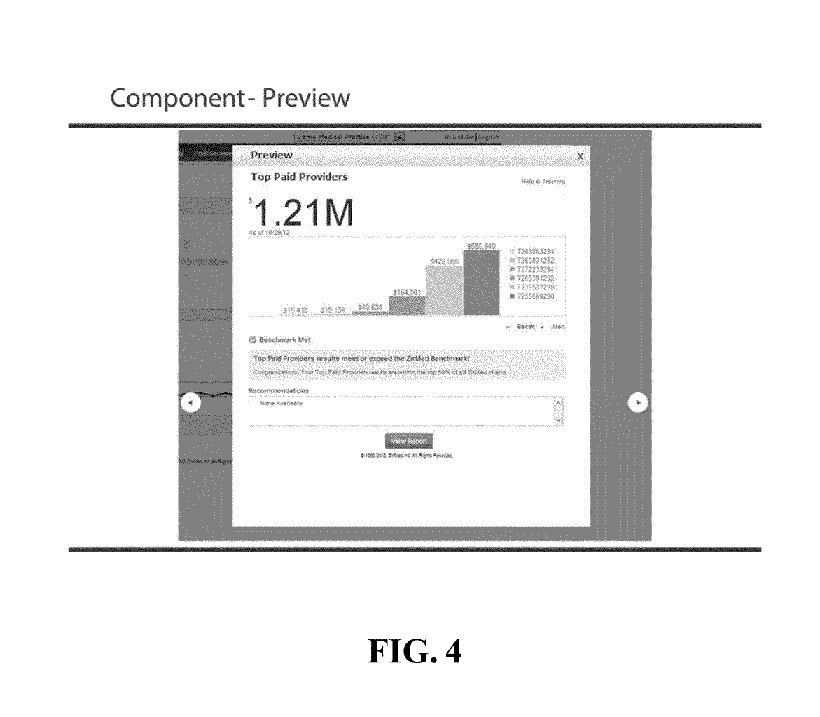

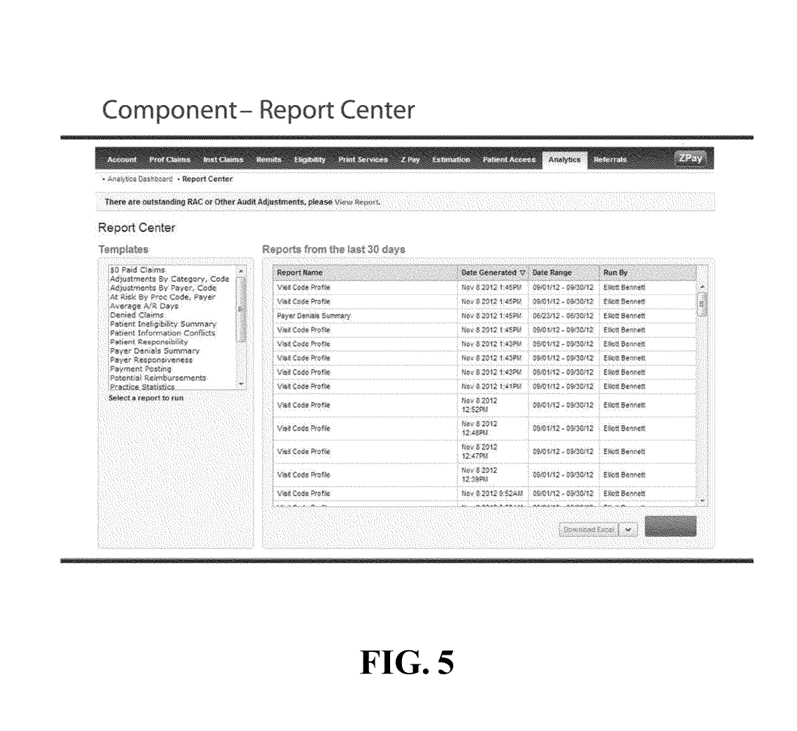

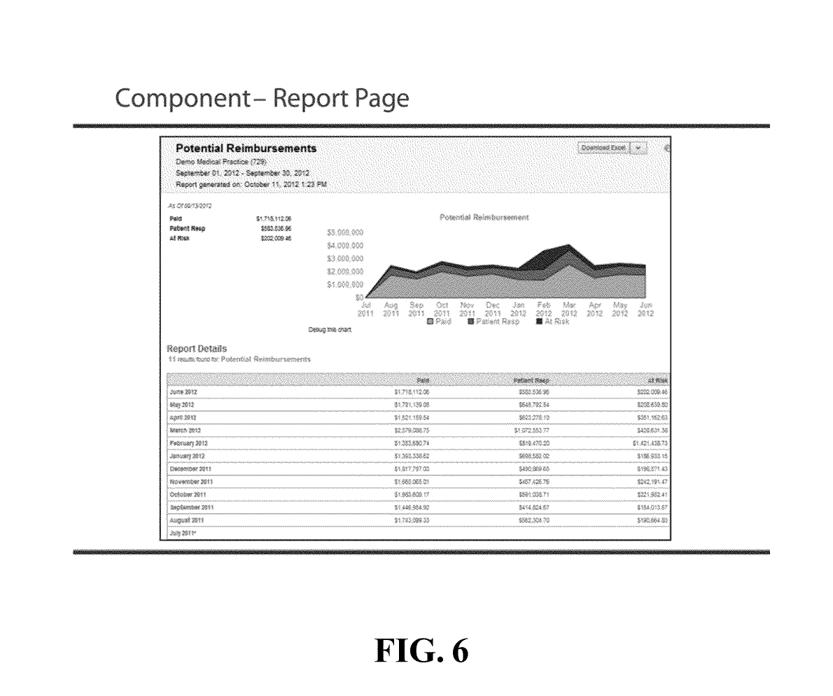

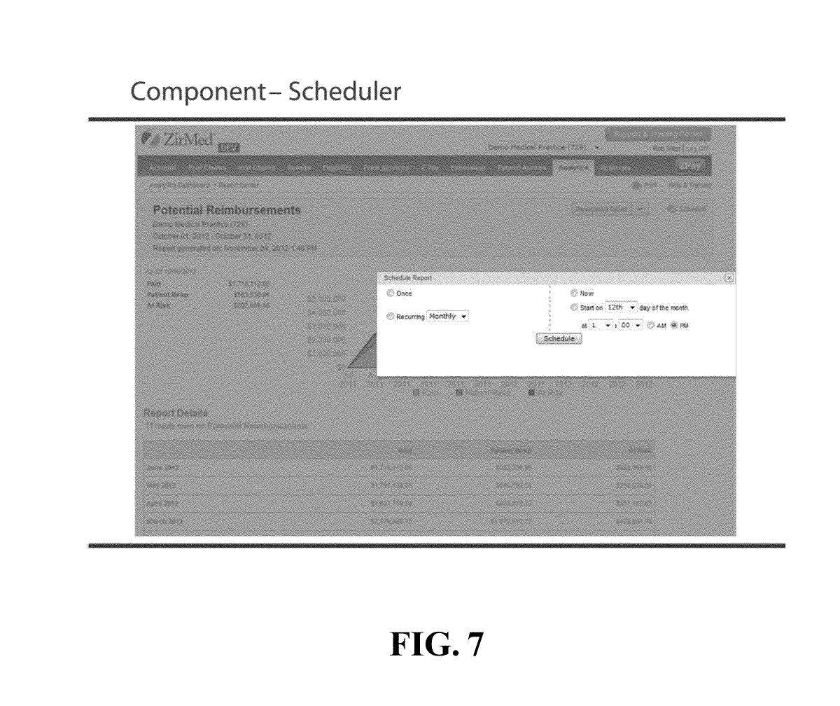

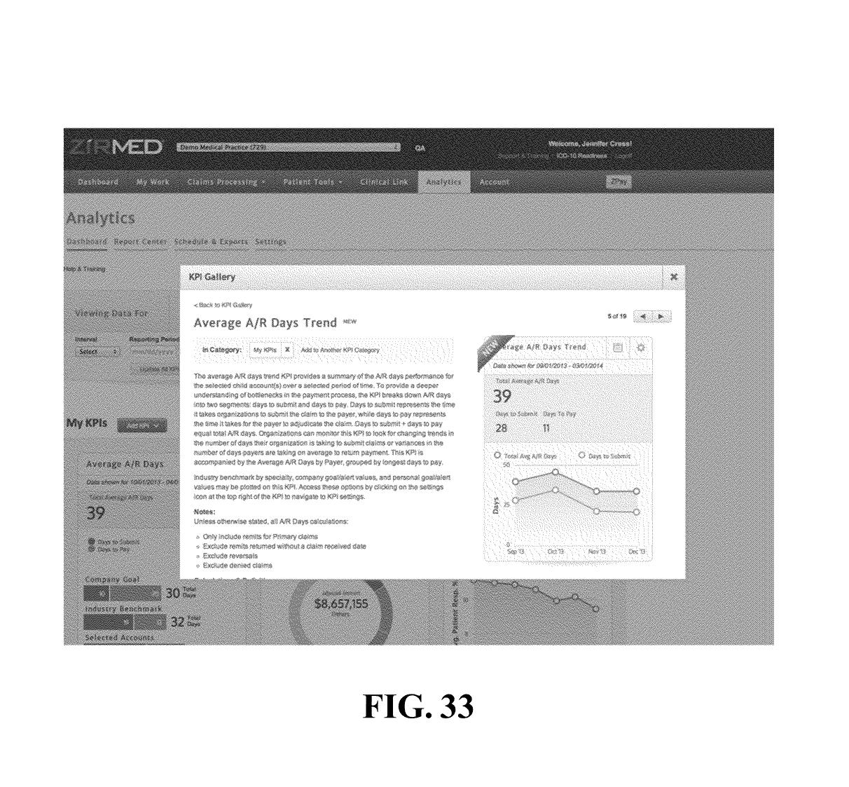

FIG. 1 illustrates the analytics components of a particular, non-limiting embodiment of a software solution 201 in accordance with the teachings herein. The software solution 201 preferably has access to a database maintained by a healthcare revenue cycle management company. As seen therein, the software solution depicted provides various functionalities which enable a healthcare provider to analyze various aspects of the provider's revenue cycle. These functionalities include a report center (FIG. 5) 203 from which various report pages (FIG. 6) may be launched to generate various reports of interest, an analytics dashboard (FIG. 3) 205 from which various analyses may be performed on the provider's revenue cycle, a key performance indicator (KPI) preview 207 (FIG. 4) from which an overview of a component from the analytics dashboard 205 may be viewed, a KPI hover 209 from which information about a KPI may be viewed by hovering over the KPI with a cursor, a web component 211 (FIG. 2), a scheduler 213 (FIG. 7) and various key performance indicators (KPIs) 215 (see, e.g., FIGS. 33-36).

FIG. 2 illustrates the web portion 211 of the software solution 201. The web portion 211 allows a user to browse the software solution 201 with a suitable web browser such as, for example, Google Chrome®, Microsoft Internet Explorer ®, or Firefox®. Various navigation functions and features 221, such as selectable arrows or page markers, are provided to allow users of devices such as smartphones (which have more limited display space) to browse the full contents of the software solution 201 in an efficient and logical fashion.

FIG. 3 depicts the analytics dashboard component 205 of the software solution 201 of FIG. 1. The analytics dashboard 205 allows a user of the software solution to quickly access the analytical capabilities of the software. In the particular embodiment depicted, the dashboard 205 provides hotlink access to the analytical capabilities of the software which may be used to analyze aspects of a healthcare provider's revenue cycle. These aspects include reports 223 on visit code overuse, late EOBs, patient ineligibility, denial rate, rejected impact, denial impact, average AR days, and top paid providers.

FIG. 4 depicts the KPI preview 207 (or component preview) functionality of the software solution 201 of FIG. 1. In a preferred embodiment, when a cursor is placed over one of the items in the analytics dashboard 205 (see FIG. 3), the item is highlighted, and the user is given a choice to select a quick preview (see FIG. 4) or to view the details of the item. This functionality allows a user to quickly gauge the status of various parameters, or to drill down for further detail if necessary.

FIG. 5 depicts the report center 203 of the software solution 201 of FIG. 1. As seen therein, the report center 203 includes a first scrollable window 225 containing a plurality of selectable templates which can be used to generate various reports relating to the revenue cycle of the healthcare provider. The report center further includes a second scrollable window 227 containing a listing of reports which were previously generated. Each of the reports in the second window 227 may be selected and viewed, and if desired, a spreadsheet (e.g., an Excel® spreadsheet) file of the data used to generate the report may be downloaded from the database associated with the revenue cycle management company. An alert pane 229 is also provided which notifies the user if there are any outstanding RAC (recovery audit contractor) or other audit adjustments which might affect the data in the reports. The user may view a report on such adjustments by selecting the “View Report” hotlink in the alert pane.

FIG. 6 depicts an example of a report 204 which may be generated with the software solution 201 disclosed herein. The particular report 204 depicted is a potential reimbursements report, and contains both numerical data 231 (regarding paid, patient responsibility, and at risk components of potential reimbursement) and a graphical depiction 233 of the numerical data. A menu 235 is also provided which allows the user to download the report in various formats (e.g., as an Excel spreadsheet). Other reports which may be generated include, but are not limited to, reports on $0 paid claims, adjustments by category and code, adjustments by payer and code, at risk by procedural code and payer, average AR (accounts receivable) days, denied claims, patient ineligibility summary, patient information conflicts, patient responsibility, payer denials summary, payer responsiveness, payment posting, potential reimbursements, and practice statistics.

FIG. 7 depicts a scheduler menu 213 which is accessible from the report center 203. The scheduler 213 may be utilized to schedule automatic report generation for any of the reports which may be generated by the software solution 201. In the particular embodiment depicted, the scheduler 213 is equipped with recurrence and timing functionality which allows the user to determine the frequency and time at which report generation occurs (e.g., as a single or recurring instance).

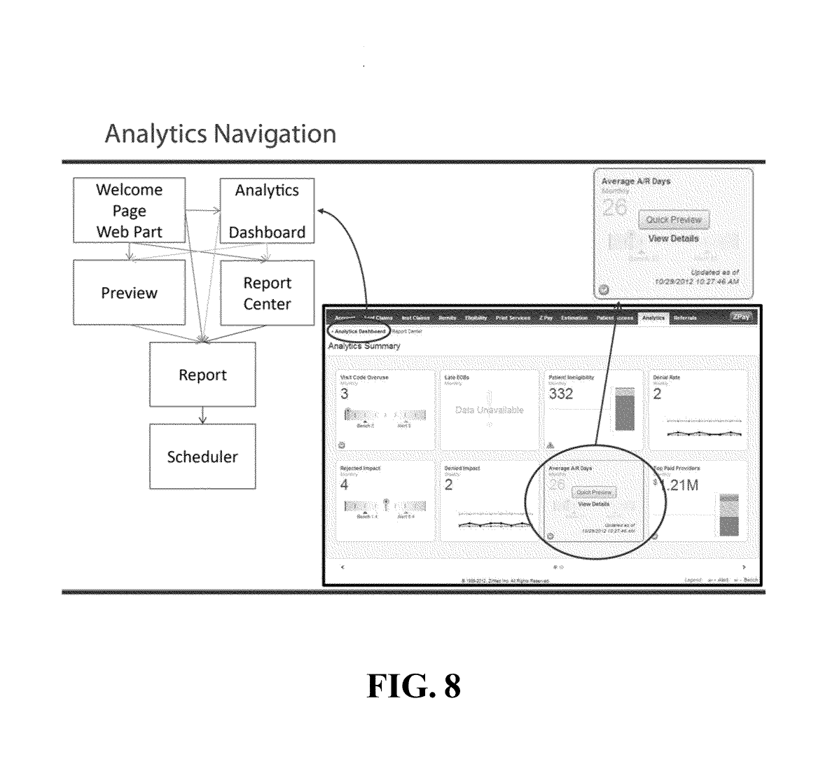

FIG. 8 depicts the manner in which a user may navigate the analytics component of the software solution 201. As seen therein, navigational features may be provided in the software solution 201 which allow a user to readily navigate between the welcome page 211, analytics dashboard 205, preview 207, report center 203, reports 204, and scheduler components 213 of the software solution 201.

In a preferred embodiment, the software solution disclosed herein is able to generate a report card on a healthcare provider. The report card shows performance metrics for each individual provider within a practice (even those that do not contribute to the PKI). The report card also shows KPIs for the top performing provider in the practice. The top performing provider may be the provider with the best collection record, or a provider that leads his or her colleagues in another suitable metric.

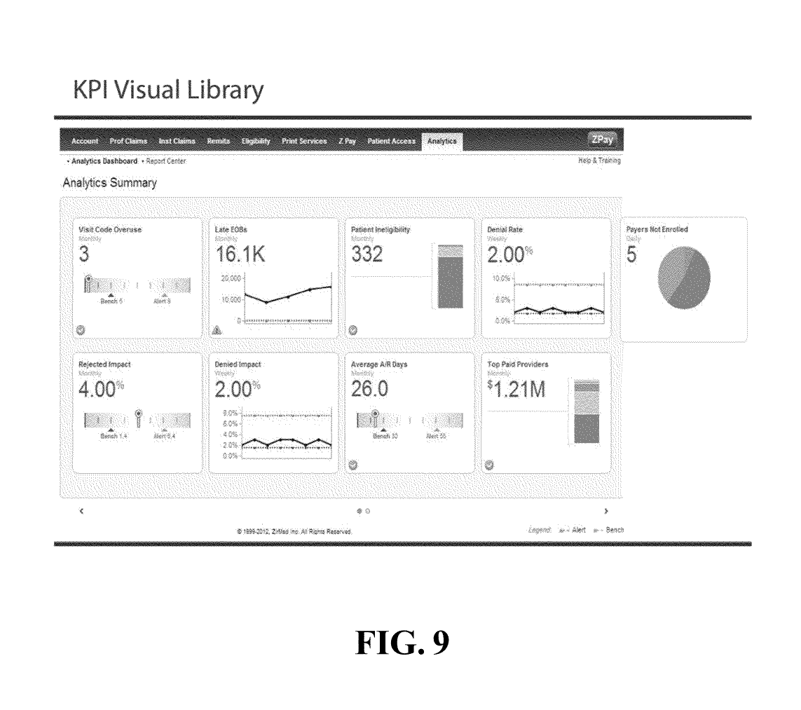

FIG. 9 depicts various KPIs that may be utilized in the systems and methodologies described herein. With reference thereto, the “Visit Code Overuse” (Count of Visit Codes) KPI 251 represents the total number of visit codes which exceed the benchmark by >5%. Each code is counted separately for each practice specialty as applicable and totaled for this KPI.

The “Late EOBs” (Count of Claims) KPI 253 represents the number of claims submitted to the payer more than 14 days ago without a matched remittance for payers where the revenue cycle management company expects to receive electronic remits.

The “Patient Ineligibility” (Count of Remits) KPI 255 represents the number of remits denied or adjusted for patient ineligibility by category. The shaded areas indicate the relative number of remits from each category.

The “Denial Rate” (Percent of Denied Remits to the Total Number of Received Remits) KPI 257 represents the 8 week trend for the denial of remits.

The “Rejected Impact” KPI 259 represents the percent of total amount rejected to the total amount billed.

The “Denied Impact” KPI 261 represents the 8-week trend for the percent of total amount denied to the total amount billed.

The “Average AR Days” (Number of Days) PKI 263 represents the average days in AR for primary payments received, calculated from the latest service date to the check date provided by the payer.

The “Top Paid Providers” KPI 265 represents the total net revenue from top providers for up to six providers by payer reimbursed amounts. The shaded areas indicate the relative amounts from each top provider.

The “Payers not Enrolled” (Count of Payers) KPI 267 represents the number of payers who could be (but are not currently) enrolled to send remits electronically.

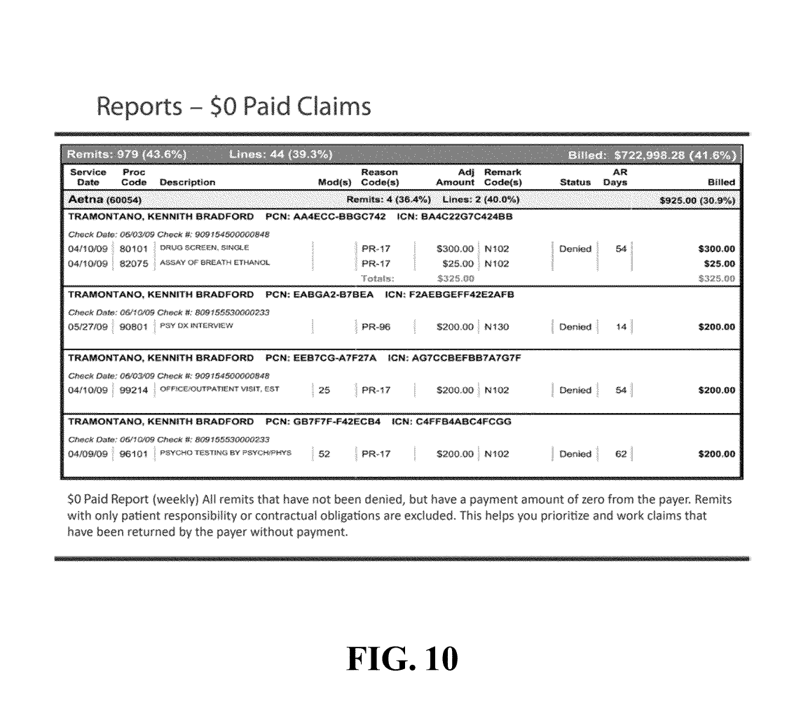

FIG. 10 illustrates the “$0 Paid Claims” report 271 which may be generated with the software solution 201 disclosed herein. This report, which typically depicts the data on a weekly basis, shows all remittances that have not been denied but have a payment amount of zero from the payer. Remittances with only patient responsibility or contractual obligations are excluded. This report helps the user to prioritize and work claims that have been returned by the payer without payment.

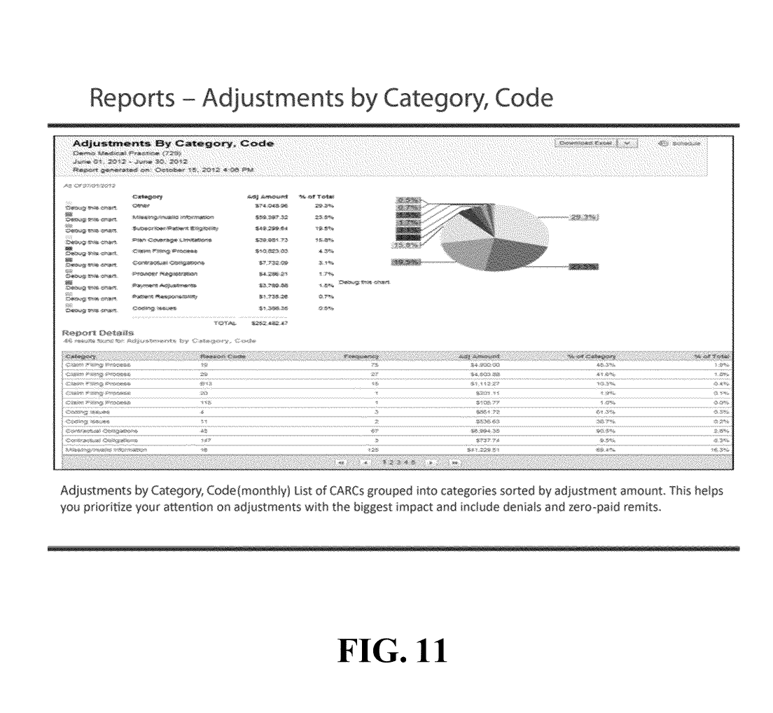

FIG. 11 illustrates the “Adjustments by Category, Code” report 273 which may be generated with the software solution 201 described herein. This report, which preferably depicts the data on a monthly basis, lists CARCs grouped into categories sorted by adjustment amount. This report helps the user prioritize attention on adjustments with the biggest impact and includes denials and zero-paid remittances.

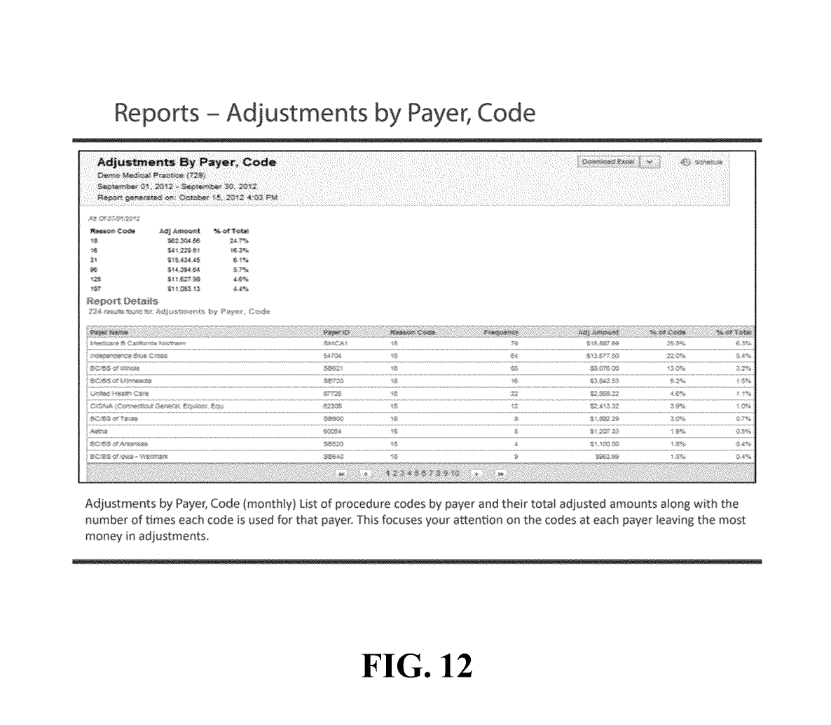

FIG. 12 illustrates the “Adjustments by Payer, Code” report 275 which may be generated with the software solution 201 described herein. This report lists procedure codes by payer and their total adjusted amounts along with the number of times each code is used for that payer. This report helps to focus attention on the codes at each payer which leave the most money in adjustments.

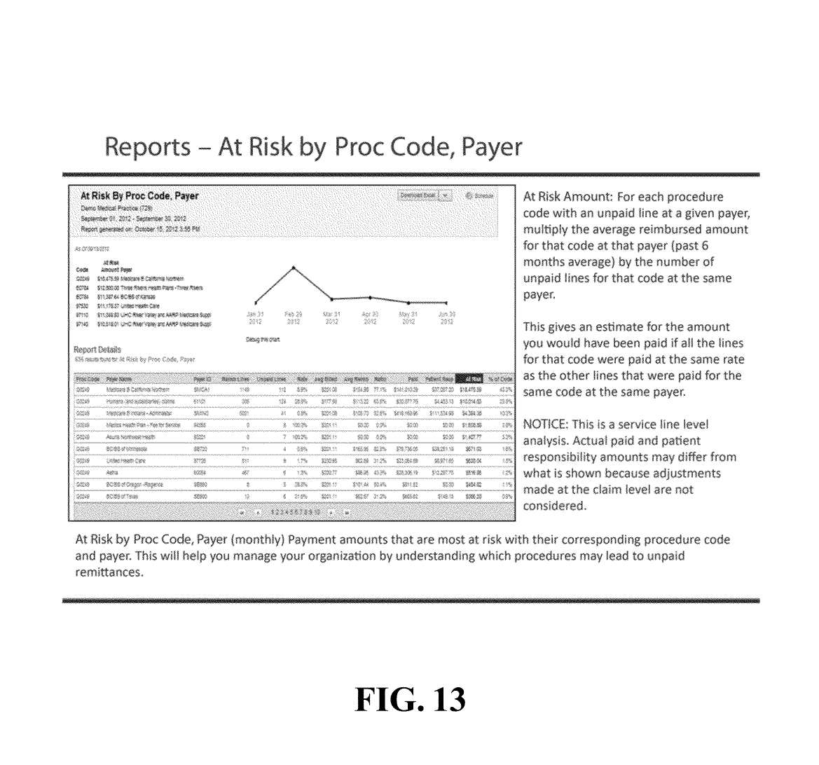

FIG. 13 illustrates the “At Risk by Procedure Code, Payer” report 277 which may be generated with the software solution 201 described herein. This report shows the payment amounts that are most at risk with their corresponding procedure code and payer. This report aids the user in managing the user's organization by understanding which procedures may lead to unpaid remittances.

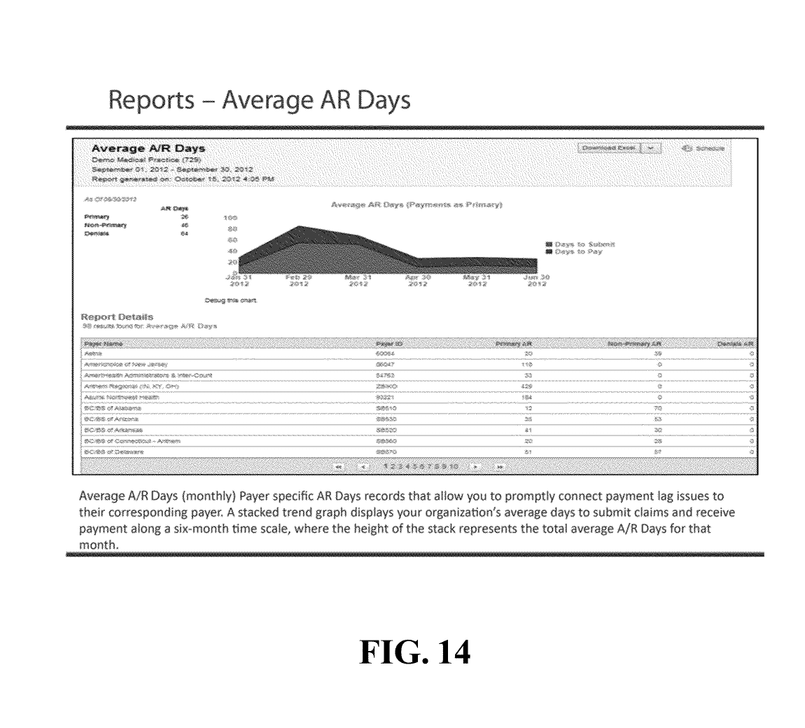

FIG. 14 illustrates the “Average AR Days” report 279 which may be generated with the software solution 201 described herein. This report, which preferably depicts the data on a monthly basis, allows the user to promptly connect payment lag issues to their corresponding payer. A stacked trend graph displays the organization's average days to submit claims and receive payment along a six-month time scale, where the height of the stack represents the total average AR days for that month.

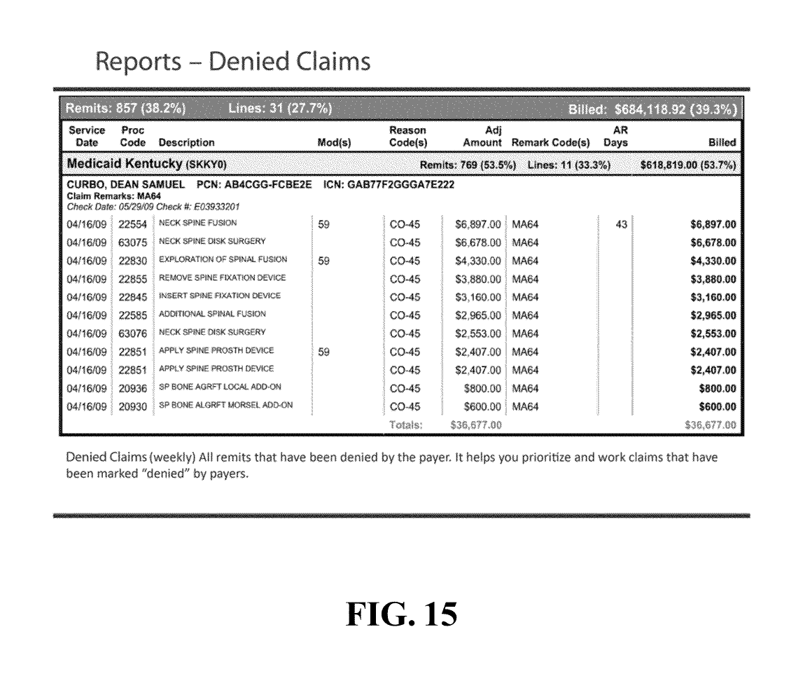

FIG. 15 illustrates the “Denied Claims” report 281 which may be generated with the software solution 201 described herein. This report shows all remittances that have been denied by the payer, and helps the user prioritize and work claims that have been marked “denied” by payers.

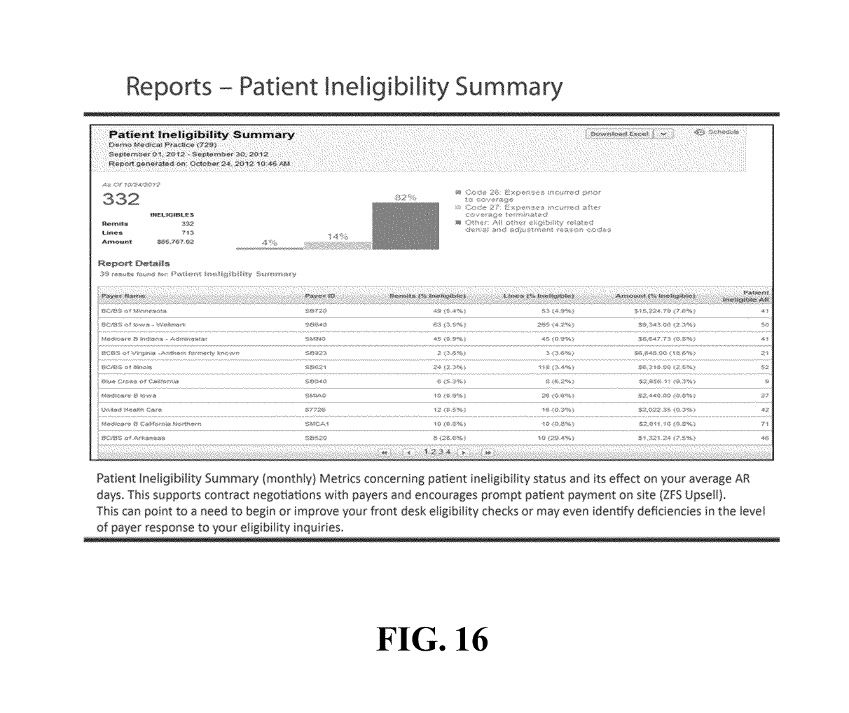

FIG. 16 illustrates the “Patient Ineligibility Summary” report 283 which may be generated with the software solution 201 described herein. This report provides metrics concerning patient ineligibility status and its effect on average AR days. This report supports contract negotiations with payers and encourages prompt patient payment on site. This report may be utilized to identify a need to begin or improve front desk eligibility checks, or may identify deficiencies in the level of payer response to eligibility inquiries.

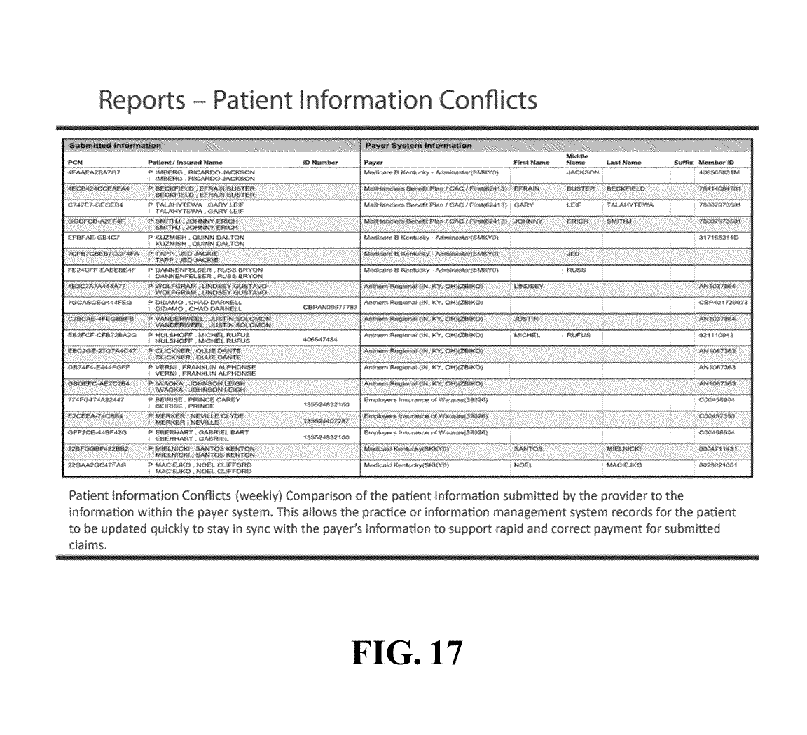

FIG. 17 illustrates the “Patient Information Conflicts” report 285 which may be generated with the software solution 201 described herein. This report provides a comparison of the patient information submitted by the healthcare provider to the information within the payer system. This report allows the practice or information management system records for the patient to be updated quickly to stay in sync with the payer's information, thus supporting rapid and correct payment for submitted claims.

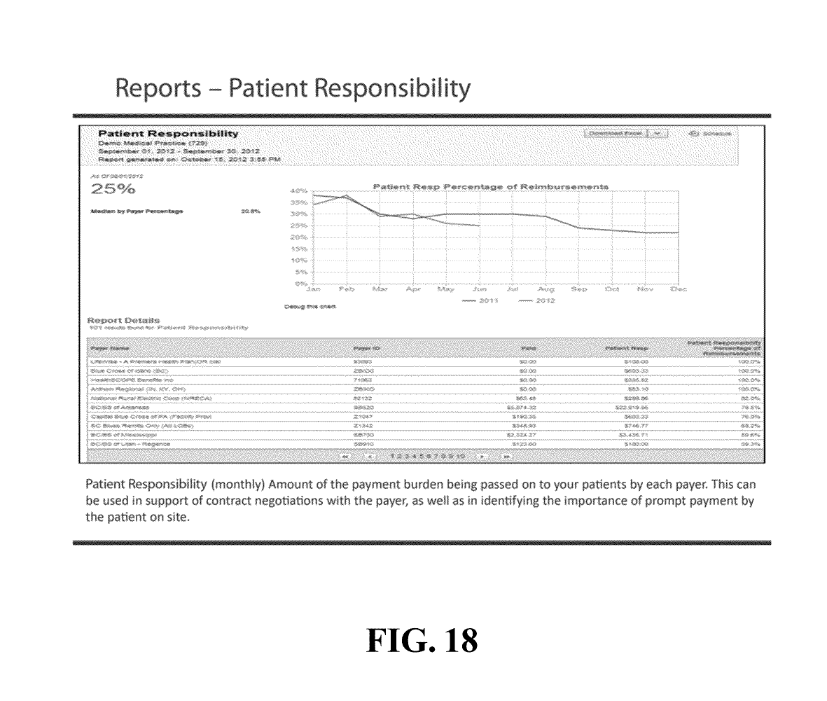

FIG. 18 illustrates the “Patient Responsibility” report 287 which may be generated with the software solution 201 described herein. This report shows the amount of the payment burden which is being passed onto the healthcare provider's patients by each payer. This report may be used in support of contract negotiations with the payer, and to identify the importance of prompt payment by the patient on the site.

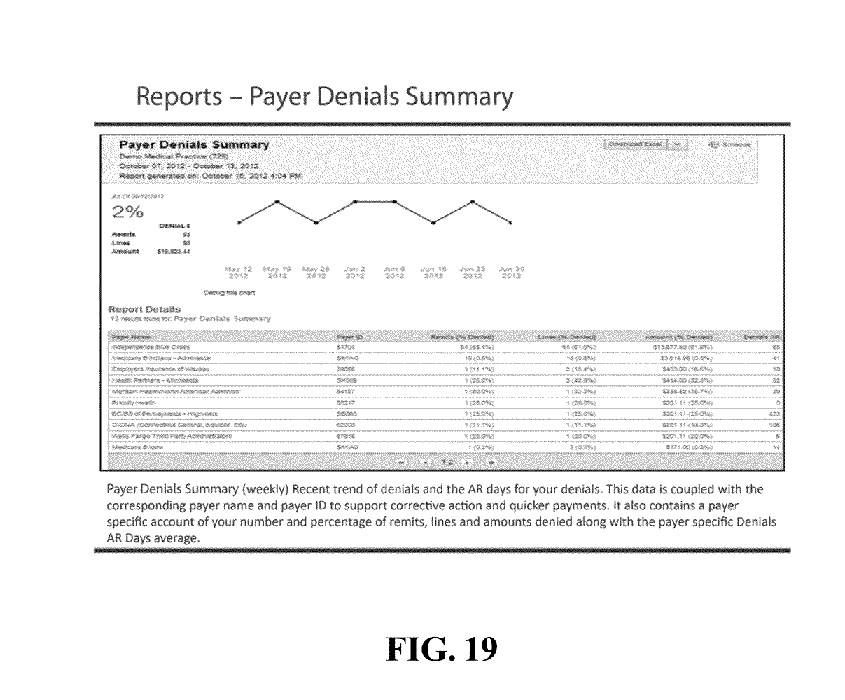

FIG. 19 illustrates the “Payers Denials Summary” report 289 which may be generated with the software solution 201 described herein. This report shows (preferably on a weekly basis) the recent trend of denials and the AR days for the healthcare provider's denials. This data is coupled with the corresponding payer name and ID to support corrective action and quicker payments. The report also contains a payer specific account of the number and percentages of the healthcare provider's remittances, lines and amounts denied, along with the payer specific average for accounts receivable days.

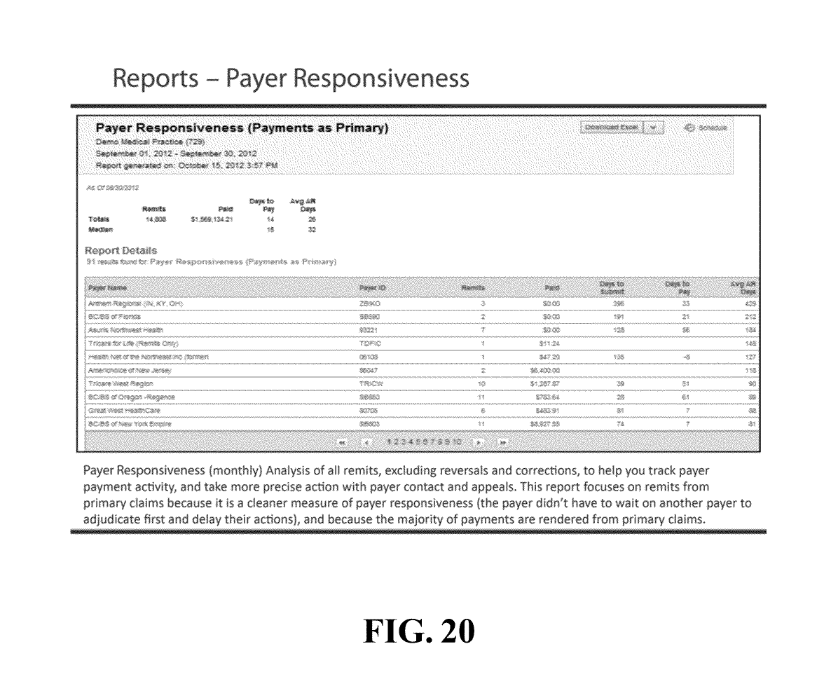

FIG. 20 illustrates the “Payer Responsiveness” report 291 which may be generated with the software solution 201 described herein. This report, which preferably depicts the data on a monthly basis, provides an analysis of all remittances, excluding reversals and corrections. This report helps a healthcare provider to track payer payment activity, and take more precise action with payer contact and appeals. This report focuses on remits from primary claims because it is a cleaner measure of payer responsiveness (because the payer didn't have to wait on another payer to adjudicate a claim first, thus delaying their actions), and because the majority of payments are rendered from primary claims.

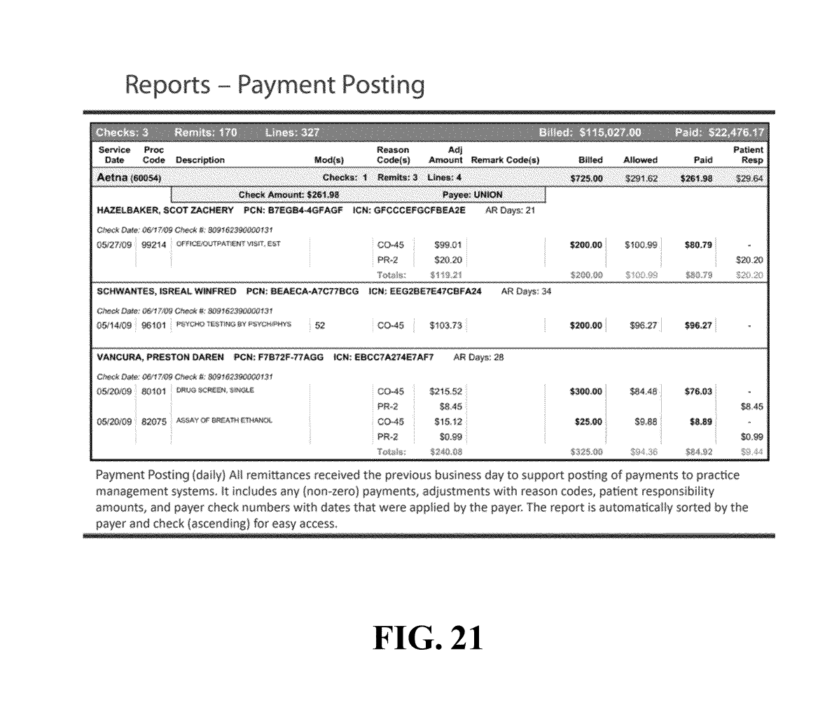

FIG. 21 illustrates the “Payment Posting” report 293 which may be generated with the software solution 201 described herein. This report shows, preferably on a daily basis, all remittances received the previous business day to support posting of payments to practice management systems. The report includes any (non-zero) payments, adjustments with reason codes, patient responsibility amounts, and payer check numbers with dates that were applied by the payer. For ease of access, the report is preferably automatically sorted (in ascending order) by payer and check.

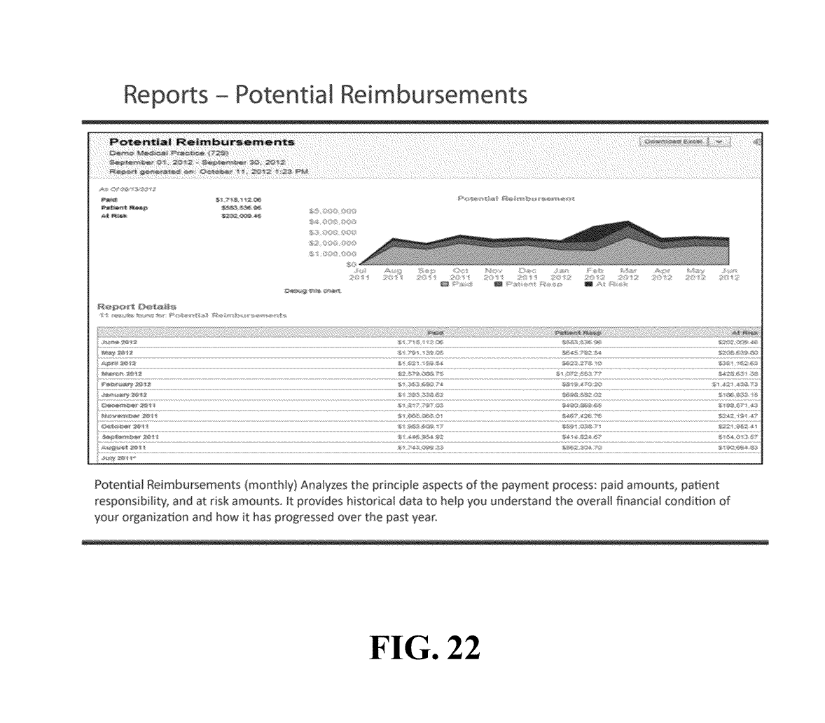

FIG. 22 illustrates the “Potential Reimbursements” report 295 which may be generated with the software solution 201 described herein. This report, which preferably depicts the data on a monthly basis, analyzes the principle aspects of the payment process, namely, paid amounts, patient responsibility, and at-risk amounts. The report provides historical data to help the user understand the overall financial condition of the healthcare organization and how it has progressed over the past year.

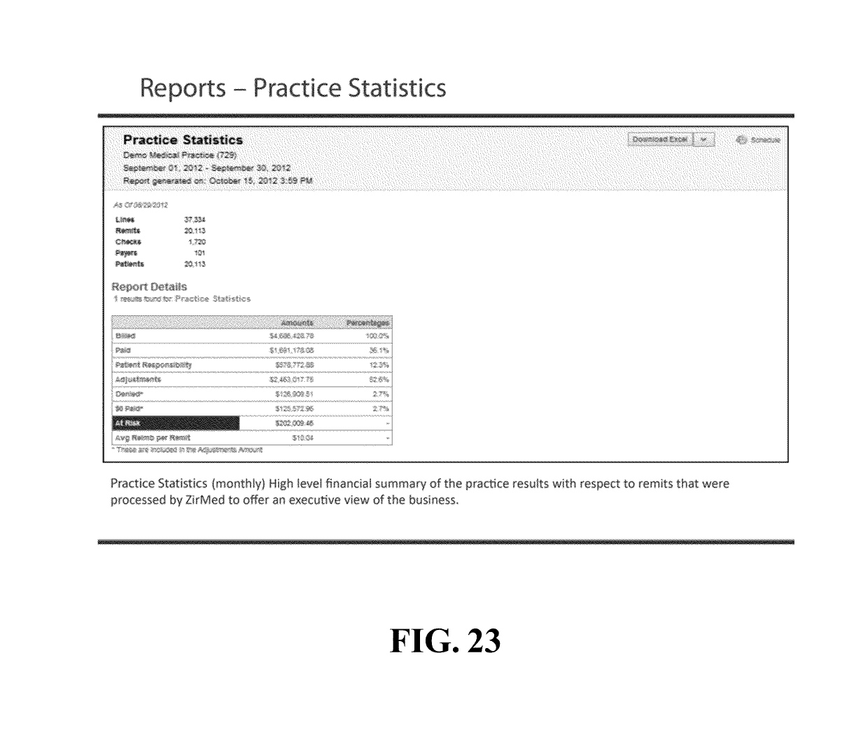

FIG. 23 illustrates the “Practice Statistics” report 297 which may be generated with the software solution 201 described herein. This report, which preferably depicts the data on a monthly basis, provides a high level financial summary of the healthcare practice results with respect to remittances that were processed by the revenue cycle management company. Hence, this report offers an executive view of the business.

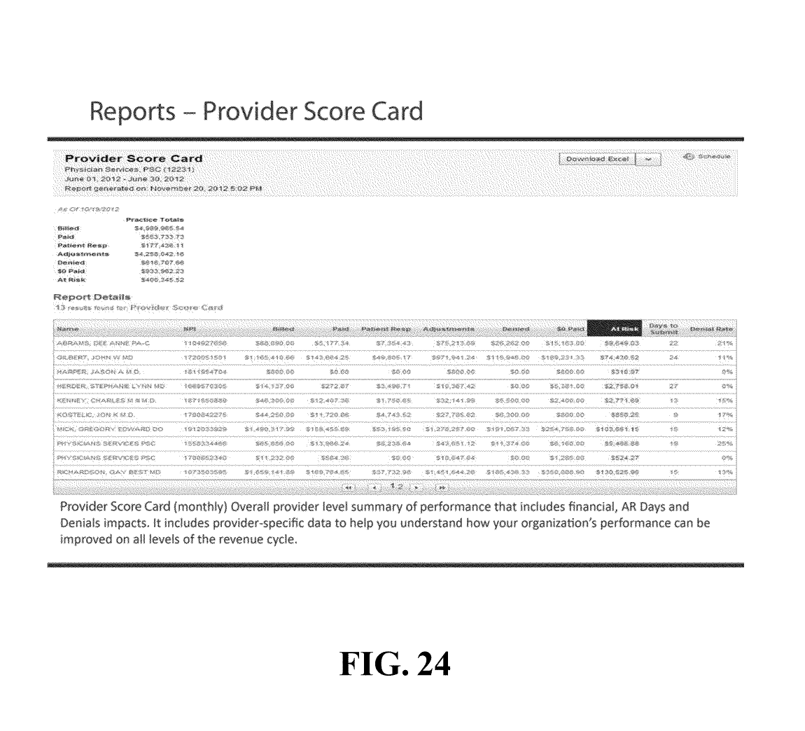

FIG. 24 illustrates the “Provider Scorecard” report 299 which may be generated with the software solution 201 described herein. This report, which preferably depicts the data on a monthly basis, provides an overall provider level summary of performance that includes financial, AR days, and denials impacts. The report includes provider-specific data to help the user understand how the healthcare organization's performance may be improved on all levels of the revenue cycle.

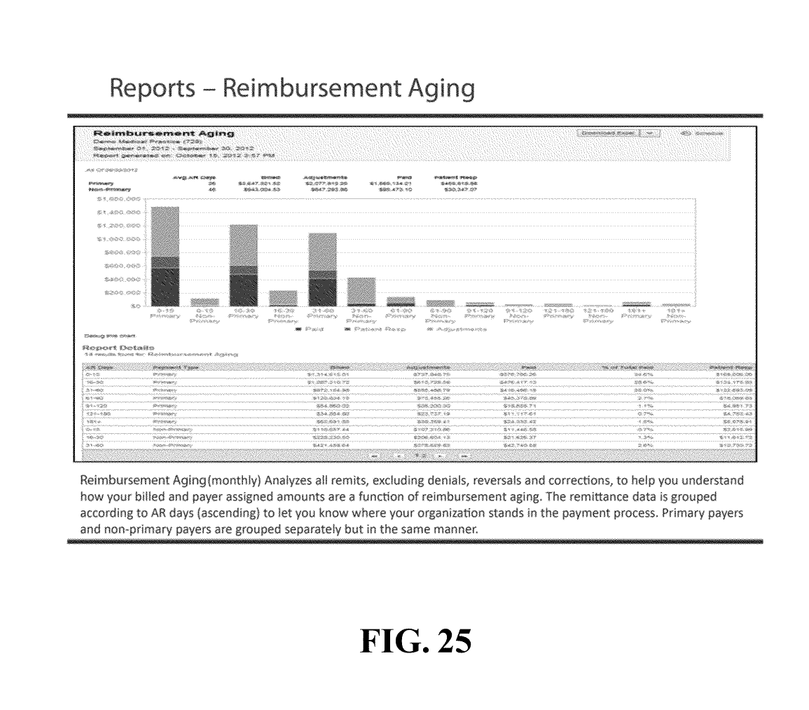

FIG. 25 illustrates the “Reimbursement Aging” report 301 which may be generated with the software solution 201 described herein. This report, which preferably depicts the data on a monthly basis, analyzes all remittances, excluding denials, reversals and corrections, to help the user understand billed and payer assigned amounts associated with the healthcare organization as a function of reimbursement aging. The remittance data is grouped according to AR days (ascending) to allow the user to readily discern where their healthcare organization stands in the payment process. Primary payers and non-primary payers are preferably grouped separately but in the same manner.

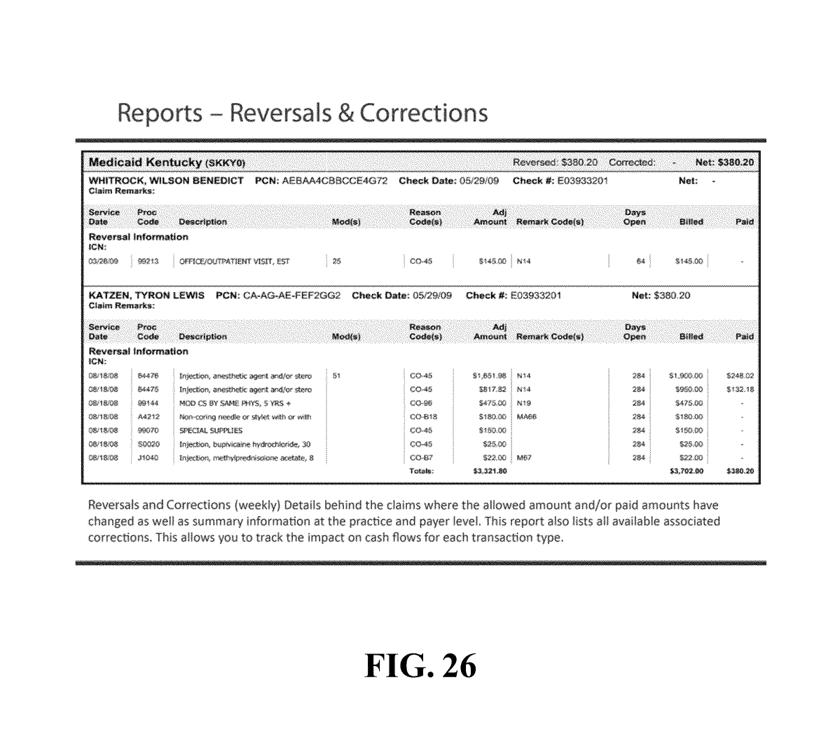

FIG. 26 illustrates the “Reversals and Corrections” report 303 which may be generated with the software solution 201 described herein. This report, which preferably depicts the data on a weekly basis, provides details behind the claims where the allowed amount and/or paid amounts have changed, and also provides summary information at the practice and payer level. This report also lists all available associated corrections, and allows the user to track the impact on cash flows for each transaction type.

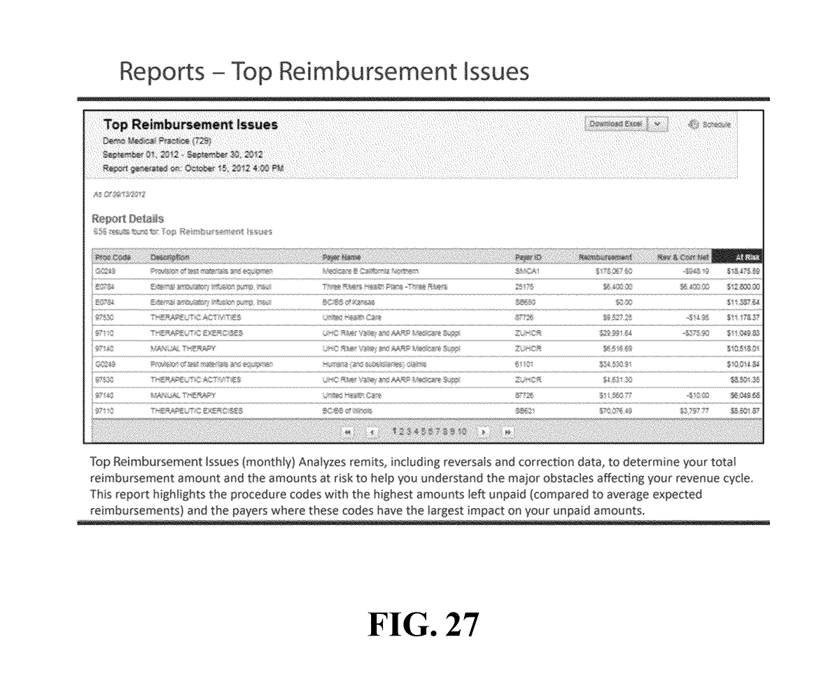

FIG. 27 illustrates the “Top Reimbursement Issues” report 305 which may be generated with the software solution 201 described herein. This report, which preferably depicts the data on a monthly basis, analyzes remits, including reversals and correction data, to determine total reimbursement amounts and the amounts at risk. Consequently, the report helps the user to understand the major obstacles affecting the revenue cycle of the healthcare practice. The report also highlights the procedure codes with the highest amounts left unpaid (compared to average expected reimbursements) and further highlights the payers where these codes have the largest impact on unpaid amounts.

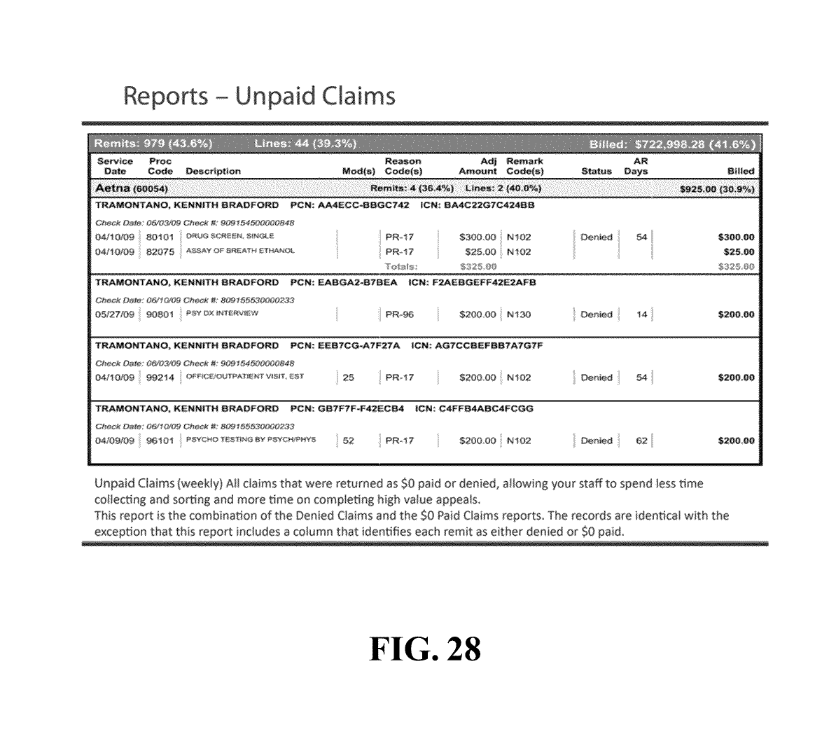

FIG. 28 illustrates the “Unpaid Claims” report 307 which may be generated with the software solution 201 described herein. This report, which preferably depicts the data on a weekly basis, shows all claims that were returned as $0 paid or denied, thus allowing the support staff of a healthcare practice to spend less time collecting and sorting and more time on completing high value appeals. This report is the combination of the “Denied Claims” (see FIG. 15) and the “$0 Paid Claims” (see FIG. 10) reports. The records are identical, with the exception that this report includes a column that identifies each remit as either denied or $0 paid.

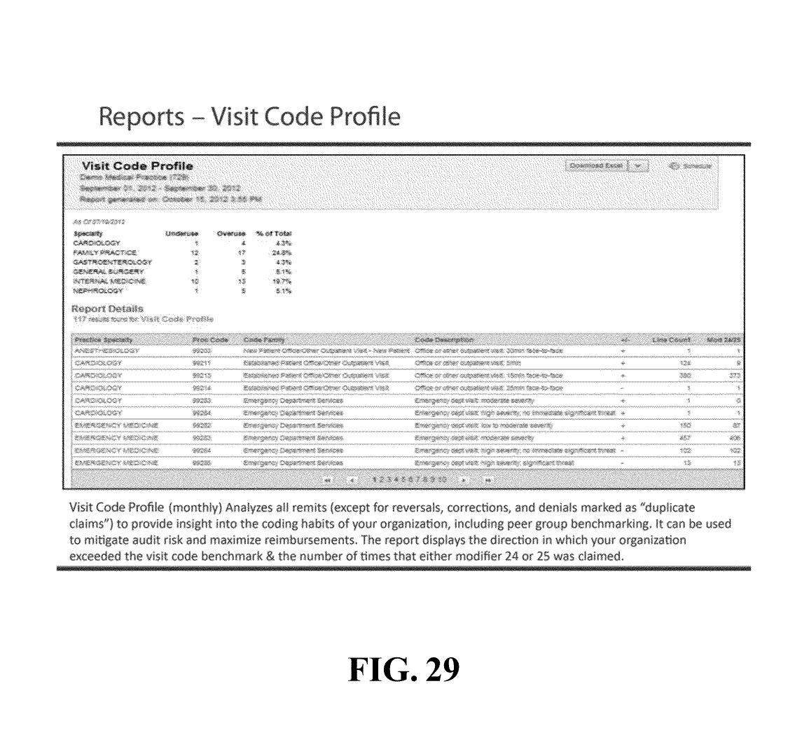

FIG. 29 illustrates the “Visit Code Profile” report 309 which may be generated with the software solution 201 described herein. This report, which preferably depicts the data on a monthly basis, analyzes all remittances (except for reversals, corrections, and denials marked as “duplicate claims”) to provide insight into the coding habits of a healthcare organization, including peer group benchmarking This report may be utilized to mitigate audit risk and to maximize reimbursements. The report displays the direction in which the healthcare organization exceeded the visit code benchmark and the number of times that either modifier 24 or modifier 25 was claimed.

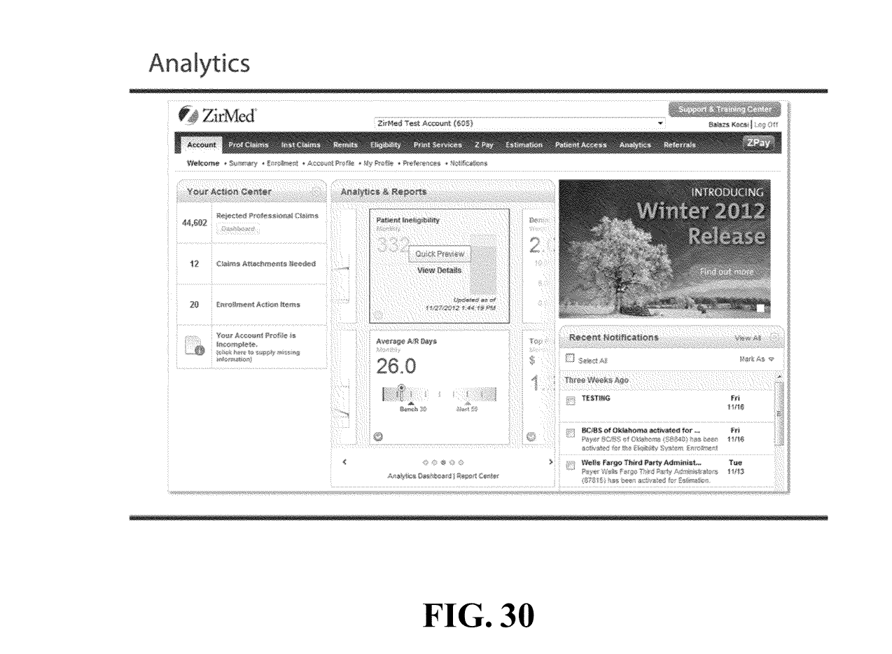

FIG. 30 illustrates an embodiment of a welcome page 321 which may be utilized in the software solution 301 described herein. As seen therein, this page provides an action center 323 which includes a listing of items requiring the user's attention, an expandable analytics and report center 325 from which reports and analytical information about the revenue cycle may be obtained, and a scrollable notification center 327 which includes chronologically arranged notifications sent to the user.

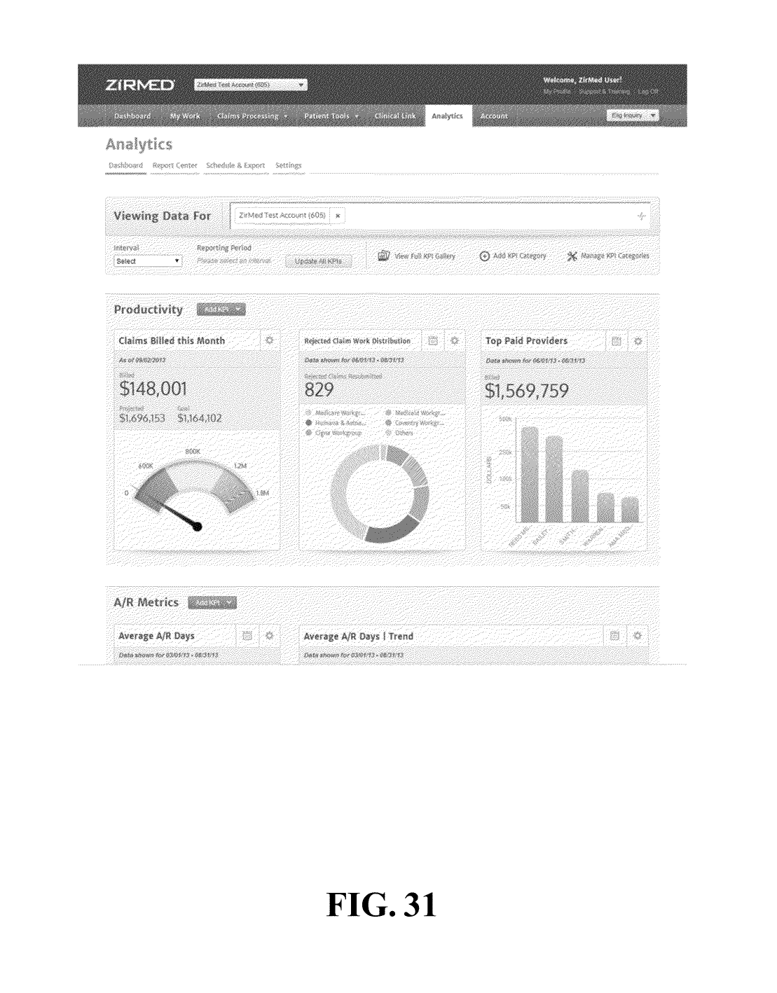

FIG. 31 illustrates an embodiment of an analytics dashboard 331 which may be utilized in the software solution 201 described herein. As seen therein, the dashboard 331 provides an overview 333 of the claims billed to date for the month, and includes the projected monthly total and the monthly goal for comparison. A visual indicator 335 (which in this particular case resembles a fuel gage) is provided which indicates the progress made to date in meeting the monthly goal. Other visual indicia are provided which depict the distribution of rejected claims and the top paid providers.

Browsing controls 337 are provided which allow the user to select the account for which the data is viewed, and to select the interval for the reporting period. Control features 339 are also provided which allow the user to update all KPIs, view the full KPI gallery, add a KPI category, manage KPI categories, or add KPIs. A section 341 is also provided in which the user can modify account receivable metrics.

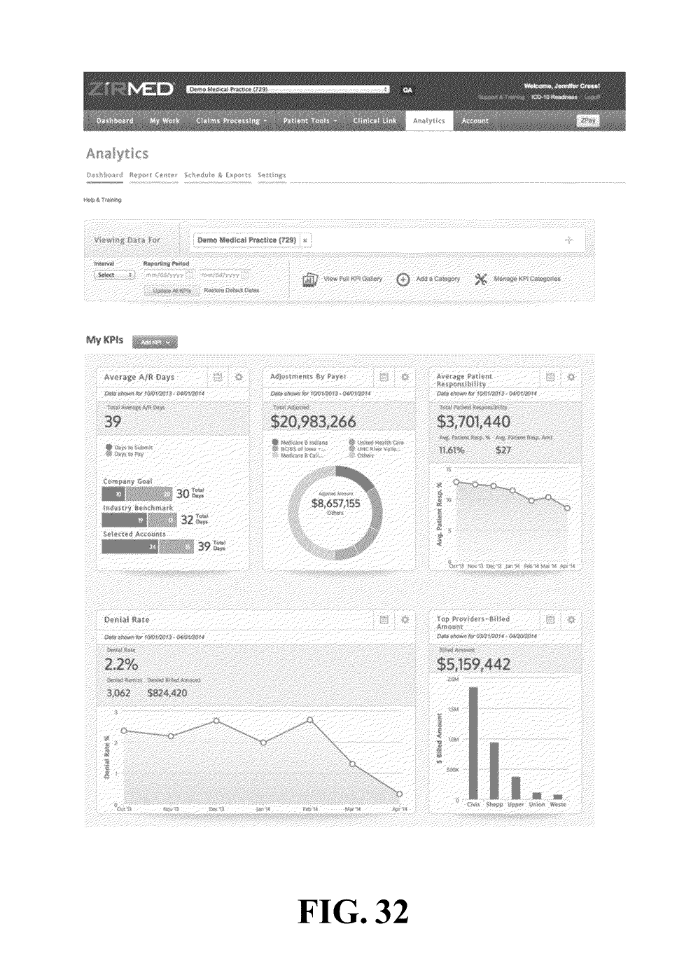

FIG. 32 depicts the window which is launched when the control feature to view the full KPI gallery is selected in FIG. 31. In the example depicted, the KPI gallery 343 includes KPIs for average accounts receivable (AR) days 345, adjustments by payer 347, average patient responsibility 349, denial rate 351, and top service providers (in terms of billed amount) 353.

As noted above, the KPI gallery also includes a control feature to add a KPI. Selection of that control feature launches the window 355 depicted in FIG. 33, in which the user can navigate through a KPI menu to select new KPIs for addition to the KPI gallery.

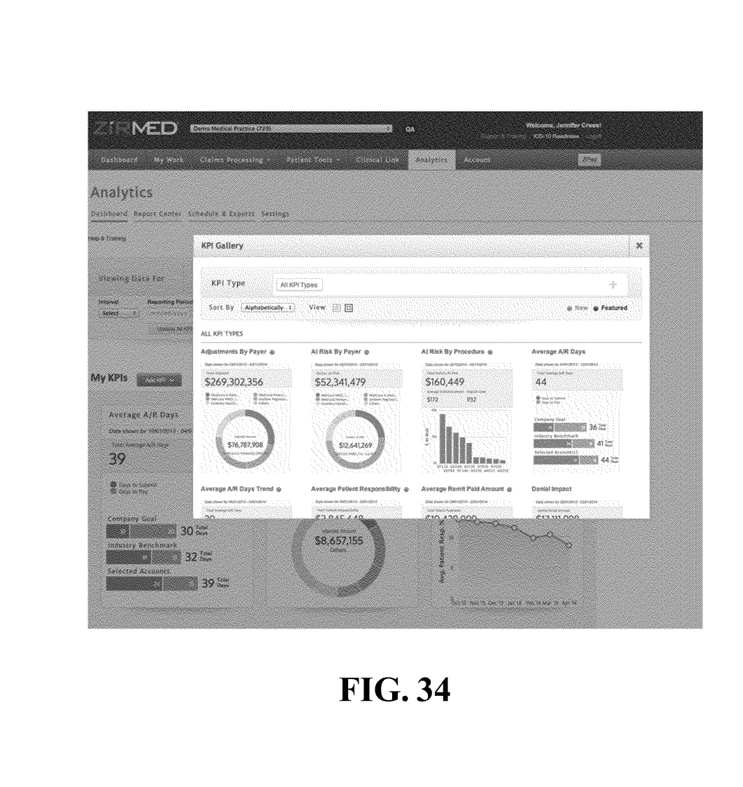

As noted above, the KPI gallery further includes a control feature to manage KPI categories. Selection of that control feature launches the window 357 depicted in FIG. 34, in which the user can determine which KPI types are displayed and can sort the KPI categories in various manners (e.g., alphabetically).

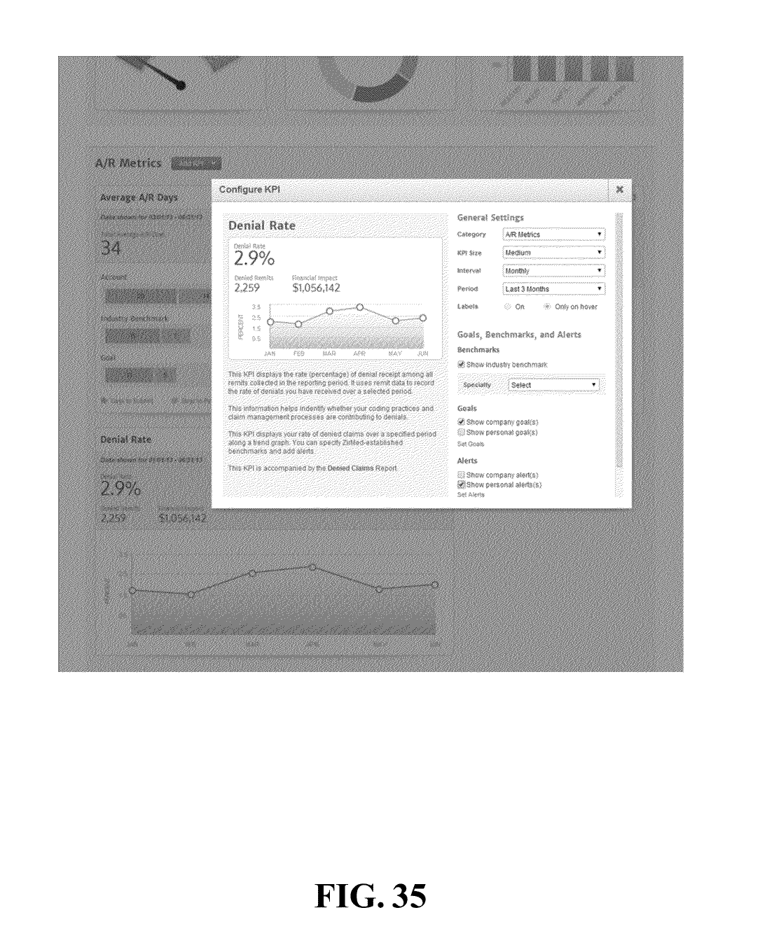

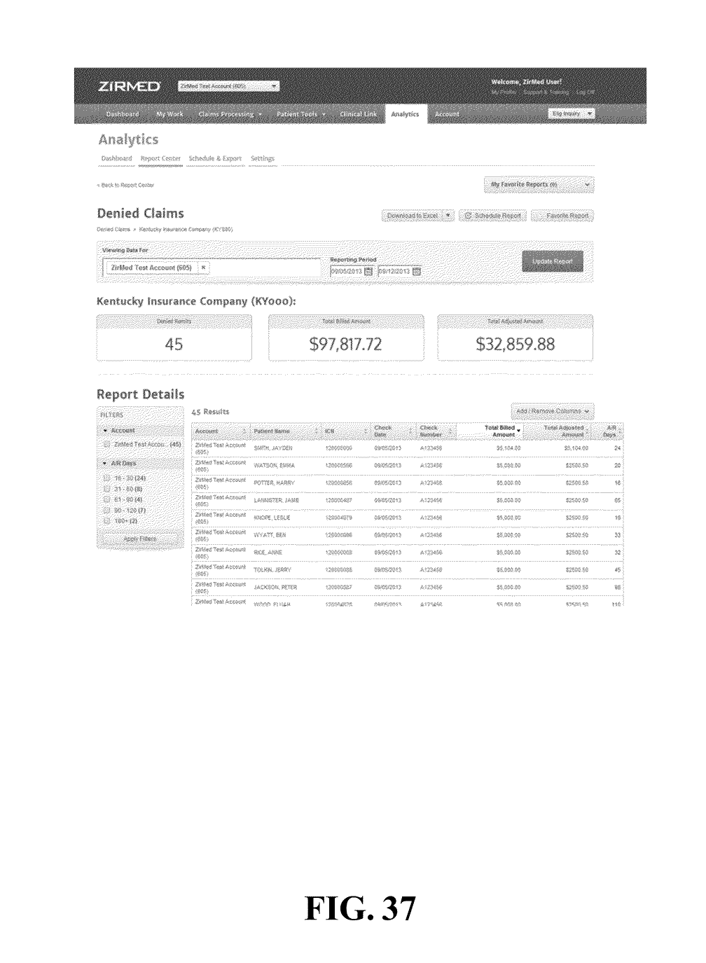

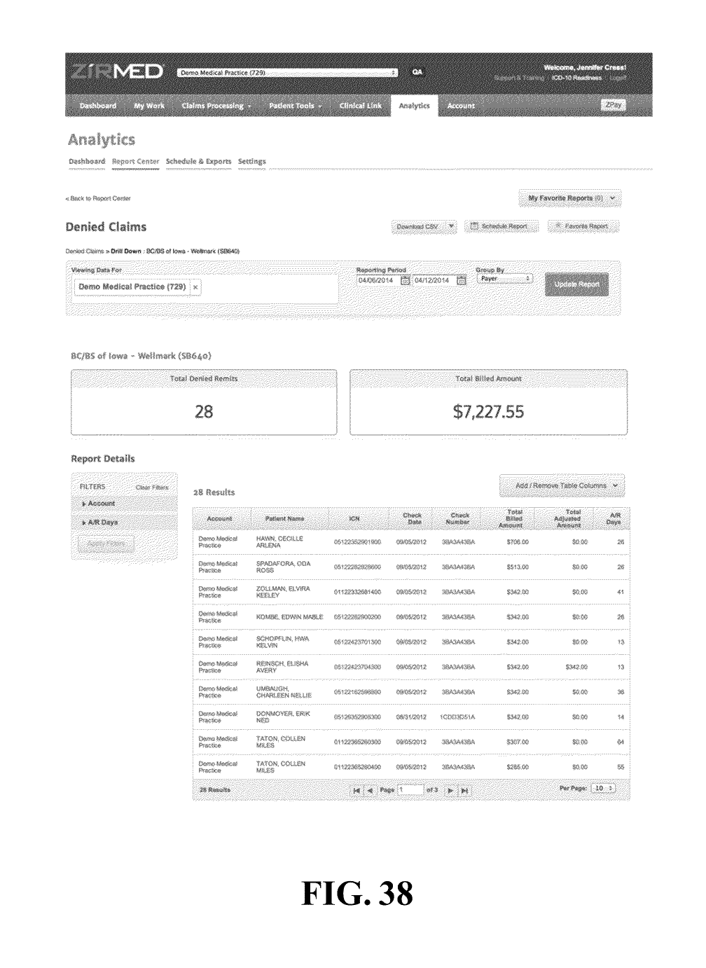

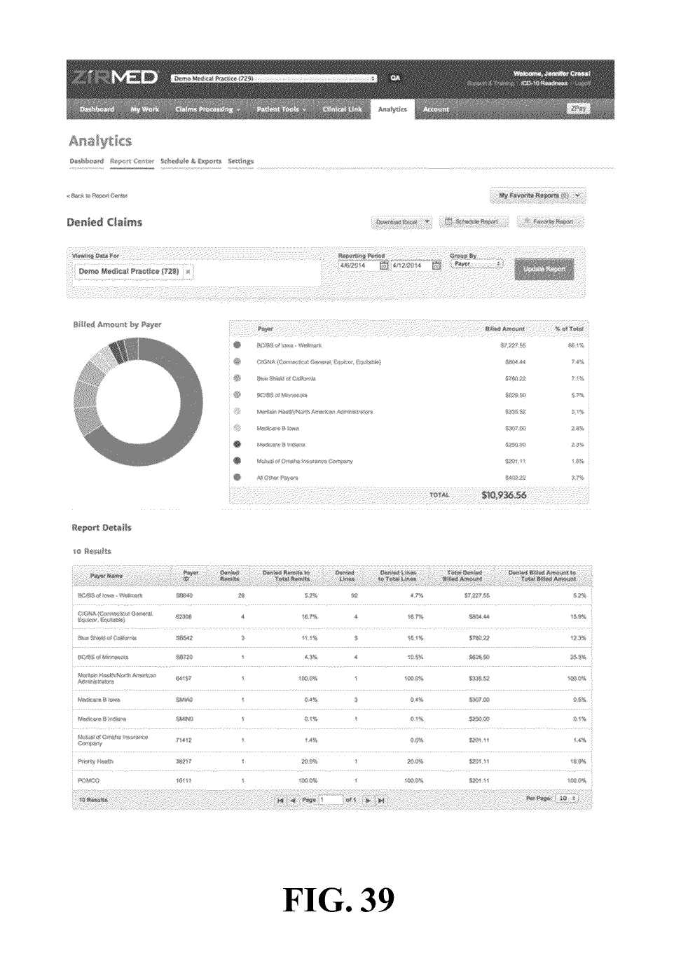

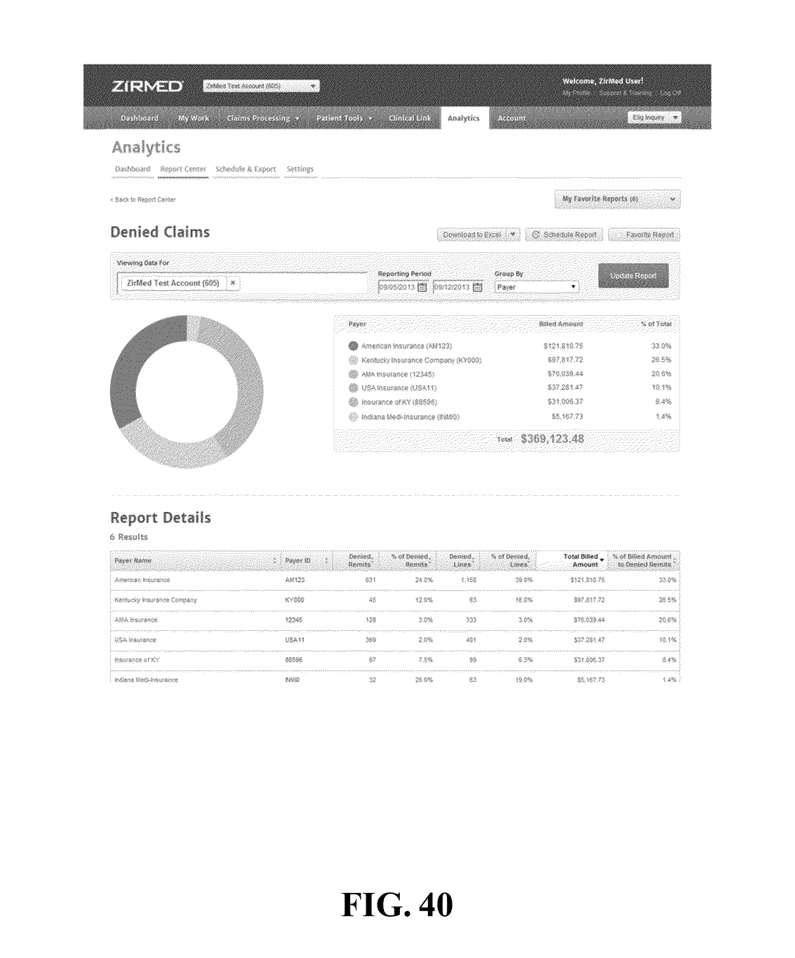

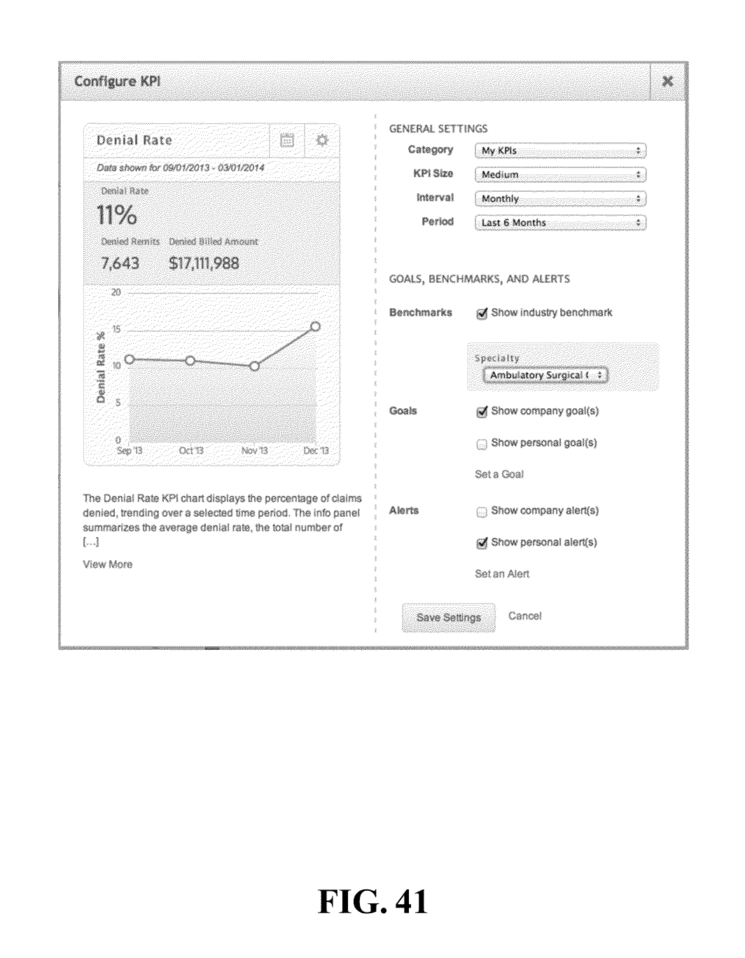

Each of the KPIs depicted in the KPI gallery is equipped with control features that allow the KPI to be configured by the user. Selection of these features launches a window 359 of the type depicted in FIG. 35 (this window, which is shown in greater detail in FIG. 41, may be expanded by clicking on it). As seen therein, this window includes a description 361 of the KPI, a general settings section 363 (in which the user can specify settings such as KPI category, size, interval, period, and label display), and a section 365 in which the user can choose settings for goals, benchmarks and alerts. FIGS. 37-40 depict different configurations of Denied Claims reports which have been configured using the general settings of FIG. 35.

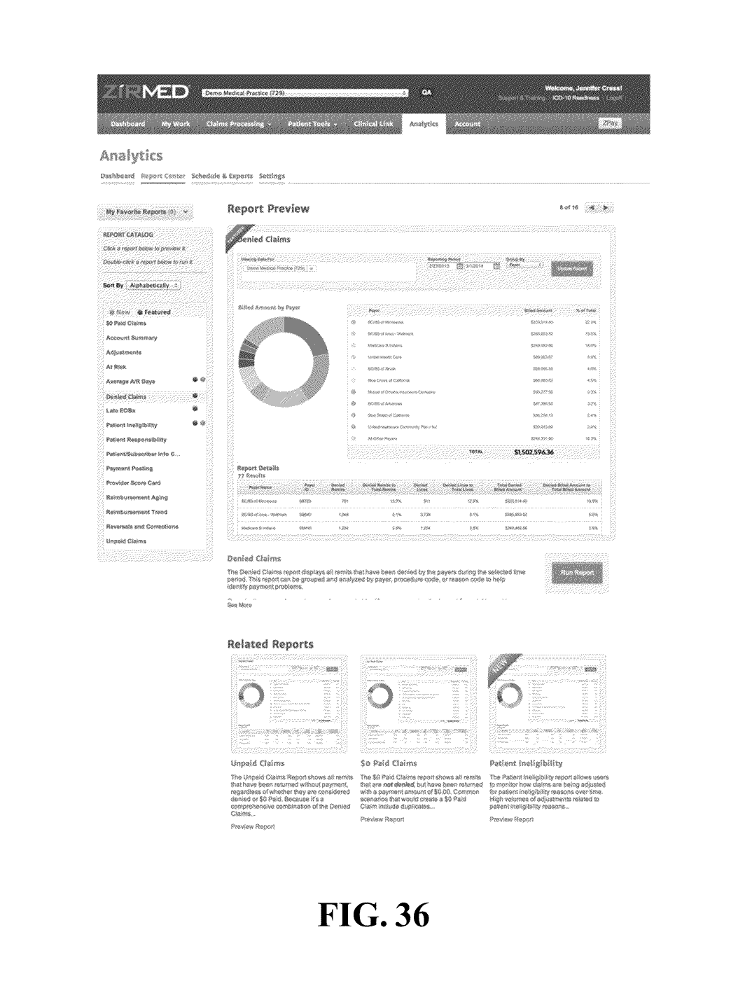

FIG. 36 depicts the window 371 which is launched when the Report Center hotlink of FIG. 31 is selected. As seen therein, this window 371 provides a menu 373 from which the user can browse reports and control how the reports are sorted. The reports may be browsed as thumbnail images. A user may preview a report by selecting the corresponding thumbnail image (any related reports are also depicted in the preview), and may run the report (see FIG. 37) by double clicking the thumbnail image or by selecting the “Run Report” control feature. The user may also add a report to a “favorites” menu 375 for quick retrieval.

It will be appreciated from the foregoing that the software solution disclosed herein contains a number of notable features. These include, but are not limited to, the provision of a KPI dashboard, the use of benchmark and performance alerts with recommendations, the ability to drill to detail reports, the ability to export data into useful forms (such as Excel® spreadsheets or CSV (comma separated values) tables), the provision of KPI preview alert text with recommendations, and the provision of a report scheduler. The functionality of the software solution may be further enhanced with an enterprise view (aggregations), customized date ranges and alerts, and benchmark enhancements. The software solution may also be implemented on smart phones or other mobile technology platforms and devices.

In some embodiments, the systems, methodologies and software disclosed herein may be implemented on one or more computational devices. Such computational devices may include one or more hardware central processing units (CPU) that carry out the functions of the device, and may also comprise an operating system configured to perform executable instructions. Such computational devices may also have the ability to connect to, access or interface with a network, a cloud computing infrastructure, an intranet, and/or one or more data storage devices. Preferably, the computational device is connected to the Internet such that it accesses the World Wide Web.

Suitable computational devices that may be utilized to implement the systems, methodologies and software disclosed herein include, but are not limited to, server computers, desktop computers, laptop computers, notebook computers, sub-notebook computers, netbook computers, netpad computers, set-top computers, handheld computers, Internet appliances, mobile smartphones, tablet computers (including those with booklet, slate, and convertible configurations), personal digital assistants, video game consoles, and vehicles. One skilled in the art will appreciate that various smartphones, televisions, video players, and digital music players with optional computer network connectivity may be suitable for use in implementing the systems, methodologies and software disclosed herein.

In some embodiments, the computational device may include an operating system which is configured to perform executable instructions. Such an operating system may comprise, for example, software (including programs and data) which manages the hardware associated with the computational device and which provides services for the execution of applications. Suitable server operating systems which may be utilized for this purpose may include, but are not limited to, FreeBSD, OpenBSD, NetBSD®, Linux, Apple® Mac OS X Server®, Oracle® Solaris®, Windows Server®, and Novell® NetWare®. Suitable personal computer operating systems which may be utilized for this purpose may include, but are not limited to, Microsoft® Windows®, Apple® Mac OS X®, UNIX®, and UNIX-like operating systems such as GNU/Linux®. Suitable operating systems for smart phones and other mobile communications devices which may be utilized for this purpose may include, but are not limited to, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. In some embodiments of the systems and methodologies described herein, the operating system may be provided, in whole or in part, through cloud computing.

In some embodiments of the systems and methodologies described herein, the computational device may include, or have associated with it, one or more storage and/or memory devices. The storage and/or memory devices may consist of one or more physical devices used to store data or programs on a temporary or permanent basis. In some embodiments of the systems and methodologies described herein, one or more of the storage and/or memory devices may have a volatile memory and may require power to maintain information stored therein.

In other embodiments of the systems and methodologies described herein, the storage and/or memory devices may be equipped with non-volatile memory (such as, for example, flash memory) which retains information stored therein when the computational device is not powered. The non-volatile memory may comprise, for example, dynamic random-access memory (DRAM), ferroelectric random access memory (FRAM) or phase-change random access memory (PRAM).

In some embodiments of the systems and methodologies described herein, the computational device may be equipped with, or in communication with, various storage devices such as, for example, CD-ROMs, DVDs, flash memory devices, magnetic disk drives, magnetic tapes drives, optical disk drives, and cloud computing based storage. In further embodiments, the storage and/or memory device may comprise various combinations or sub-combinations of the foregoing devices.

In some embodiments of the systems and methodologies described herein, the computational device may include a display to communicate information visually to a user. The display may be, for example, a cathode ray tube (CRT) display, a liquid crystal display (LCD), a thin film transistor liquid crystal display (TFT-LCD), an organic light emitting diode (OLED) display, a plasma display, a video display, a heads-up display, or the like.

In some embodiments of the systems and methodologies described herein, the computational device may include or be equipped with one or more input devices to receive information from a user. Such input devices may include, for example, various tactile devices, keyboards, pointing devices (such as, for example, mice, trackballs, track pads, joysticks, game controllers, or styluses), touch screens or multi-touch screens, microphones, video cameras, or various combinations or sub-combinations of the foregoing input devices.

In some embodiments of the systems and methodologies described herein, the computational device may include a non-transitory, computer readable, and preferably tangible storage medium or media which is encoded with a program or other operating instructions that are executable by the operating system of the computational device or by another device that the computational device is in communication with. These instructions may include instructions for the purpose of implementing the systems and methods disclosed herein. In some embodiments, the computer readable storage medium may be removable from the computational device. The computer readable storage medium may include, but is not limited to, CD-ROMs, DVDs, flash memory devices, solid state memory, magnetic disk drives, magnetic tape drives, optical disk drives, cloud computing systems and services, and the like. The program or other operating instructions may be permanently, substantially permanently, semi-permanently, or non-transitorily encoded on the medium or media.

In some embodiments of the systems and methodologies described herein, the computational device may include one or more computer programs in the form of a sequence of instructions which are executable in the computational device's CPU, and which are written to perform a specified task. These computer readable instructions may be implemented as program modules, such as functions, objects, Application Programming Interfaces (APIs), data structures, and the like, that perform particular tasks or implement particular abstract data types, and may be written in various versions of various languages.

In the systems and methodologies described herein, the functionality of the computer program (or programs) or computer readable instructions may be combined or distributed as desired in various environments. For example, any computer program utilized in the systems and methodologies described herein may comprise one or more sequences of instructions which may be provided from one or more locations, and may include one or more software modules. In some embodiments, such a computer program may include, in part or in whole, one or more components selected from the group consisting of web applications, mobile applications, standalone applications, and web browser plug-ins, extensions, add-ins, and add-ons.

In some embodiments of the systems and methodologies described herein, such a computer program may include a web application which, in various embodiments, may utilize one or more software frameworks and one or more database systems. In some embodiments of the systems and methodologies disclosed herein, the web application may be created upon a software framework such as Microsoft® .NET or Ruby on Rails (RoR), and may utilize one or more database systems such as, for example, relational, non-relational, object oriented, associative, or XML database systems. Relational database systems that may be utilized may include, for example, Microsoft® SQL Server, mySQL™, and Oracle®. Moreover, the web application may be written in one or more versions of one or more languages such as, for example, markup languages, presentation definition languages, client-side scripting languages, server-side coding languages, database query languages, or various combinations or sub-combinations thereof

In some embodiments of the systems and methodologies described herein, the web application may be written at least partially in (a) a markup language such as Hypertext Markup Language (HTML), Extensible Hypertext Markup Language (XHTML), or eXtensible Markup Language (XML); a presentation definition language such as, for example, Cascading Style Sheets (CSS); a client-side scripting language such as, for example, Asynchronous Javascript and XML (AJAX), Flash® Actionscript, Javascript, or Silverlight®; a server-side coding language such as, for example, Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy; or a database query language such as, for example, Structured Query Language (SQL).

In some embodiments of the systems and methodologies described herein, the web application may integrate enterprise server products such as, for example, IBM® Lotus Domino®. The web application may also include a media player element which may utilize one or more suitable multimedia technologies such as, for example, Adobe® Flash®, HTML 5, Apple® QuickTime®, Microsoft® Silverlight , Java™, or Unity®.

In some embodiments of the systems and methodologies described herein, a computer program may be utilized which includes a mobile application which is provided to a mobile computational device or mobile technology platform. The mobile application may be provided to the mobile computational device at the time it is manufactured or at a later time by way of download over a suitable network. The mobile application may be created by techniques known to the art using hardware, languages, and development environments which are also known to the art, and may be written in several languages. Suitable programming languages include, for example, C, C++, C#, Objective-C, Java™, Javascript, Pascal, Object Pascal, Python™, Ruby, VB.NET, WML, and XHTMLHTML with or without CSS, and various combinations or sub-combinations thereof.

Several mobile application development environments are known to the art and may be utilized in the development of the mobile application. These include, without limitation, AirplaySDK, alcheMo, Appcelerator®, Celsius, Bedrock, Flash Lite, .NET Compact Framework, Rhomobile, WorkLight Mobile Platform, Lazarus, MobiFlex, MoSync, and Phonegap. Several mobile device manufacturers also currently distribute software developer kits including, for example, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for the distribution of mobile applications. These include, for example, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the systems and methodologies described herein may utilize a computer program which includes one or more standalone applications. Such standalone applications may be programs that are run as an independent computer process (that is, not as an add-on to an existing process, e.g., not a plug-in). Such standalone applications are often compiled. A compiler is a computer program(s) that transforms source code written in a programming language into binary object code such as assembly language or machine code. Suitable compiled programming languages may include, by way of example, C, C++, Objective-C, COBOL, Delphi, Eiffel, Java™, Lisp, Python™, Visual Basic, and VB .NET. Compilation is often performed, at least in part, to create an executable program. In some embodiments of the systems and methodologies described herein, the computer program may include one or more executable complied applications.

In some embodiments, the systems and methodologies described herein may include software, server, and/or database modules, or use of the same. Such software modules may be created by techniques known to the art (possibly by using machines, software, and languages known to the art), and may be implemented in various ways. These software modules may comprise one or more files, section of codes, programming objects, programming structures, or various combinations or sub-combinations thereof. In some embodiments of the systems and methodologies described herein, the software modules may comprise a web application, a mobile application, and/or a standalone application. The software modules may be present in one or more computer programs or applications, and may be hosted on one or more machines or cloud computing platforms which may be in one or more locations.

In some embodiments, the systems and methodologies described herein may include one or more databases, or use of the same. Such databases may include, for example, relational databases, non-relational databases, object oriented databases, object databases, entity-relationship model databases, associative databases, and XML databases. These databases may be Internet-based, web-based, cloud computing-based, or may be based on one or more local computer storage devices.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A system for comparing parameters of the revenue cycle of a healthcare provider to benchmark values, the system comprising:
a revenue cycle management company which manages the revenue cycles of a plurality of healthcare providers, wherein each of said revenue cycles includes the submission of healthcare claims by one of said healthcare providers to a plurality of healthcare payers, and the receipt of healthcare claim payments and remittance advice from the plurality of healthcare payers in response to the submitted healthcare claims;
a database associated with said revenue cycle management company, wherein said database contains data relating to a plurality of parameters of the revenue cycle of each of said plurality of healthcare providers; and
a non-transitory, computer readable medium having recorded therein a software program that contains suitable programming instructions which, when executed by a data processing apparatus, cause the data processing apparatus to perform a method for:
(a) deriving from the database a plurality of performance benchmarks, wherein each performance benchmark corresponds to one of said plurality of parameters, and
(b) displaying on a display a graphical depiction of the comparison of the value of at least one of said plurality of parameters for the revenue cycle of one of said plurality of healthcare providers to the benchmark corresponding to said parameter.

2. The system of claim 1, wherein each of the revenue cycle performance benchmarks is a median value of a revenue cycle performance parameter.

3. The system of claim 1, wherein each of the revenue cycle performance benchmarks is a mean value of a revenue cycle performance parameter.

4. The system of claim 1, wherein the method performed by the data processing apparatus further includes:
determining the value of each of the plurality of revenue cycle performance parameters periodically, thereby obtaining the plurality of determined values.

5. The system of claim 4, wherein the method performed by the data processing apparatus further includes:
if the determined value exceeds a user specified alert value, sending an alert to the user that the determined value has exceeded the alert value.

6. The system of claim 4, wherein the method performed by the data processing apparatus further includes:
displaying a graphical user interface (GUI) which depicts the benchmark values, the alert values and the determined values.

7. The system of claim 6, wherein the method performed by the data processing apparatus further includes:
displaying the benchmark values, the alert values and the determined values on an indicator bar having a plurality of numerical values indicated thereon.

8. The system of claim 6, wherein the method performed by the data processing apparatus further includes:
displaying each determined value in a pane with the associated benchmark value and alert value, wherein each of the determined values is displayed in a separate pane.

9. The system of claim 6, wherein the determined values include determined values for average accounts receivable days.

10. The system of claim 6, wherein the determined values include determined values for visit code overuse.

11. The system of claim 6, wherein the determined values include determined values for rejected impact.

12. The system of claim 6, wherein the determined values include determined values for late explanations of benefit (EOBs).

13. The system of claim 6, wherein the determined values include determined values for claim denial rates.

14. The system of claim 6, wherein the method performed by the data processing apparatus further comprises:
providing a settings window wherein a user is prompted to input a start time for the generation of the benchmark values, the alert values and the determined values.

15. The system of claim 6, wherein the method performed by the data processing apparatus further comprises:
prompting the user to input a reoccurrence interval which determines the interval at which the benchmark values, the alert values and the determined values are regenerated.

16. The system of claim 15, wherein the method performed by the data processing apparatus further comprises:
generating the benchmark values, the alert values and the determined values at the start time of the interval input by the user.

17. A method for assessing the revenue cycle of a healthcare provider, the system comprising:
deriving a revenue cycle performance benchmark for each of a plurality of revenue cycle performance parameters, wherein each revenue cycle performance benchmark is derived from a database containing data relating to the revenue cycles of a plurality of other healthcare providers;
determining the value of each of the plurality of revenue cycle performance parameters for the healthcare provider, thereby obtaining a plurality of determined values; and
displaying a graphical depiction of the comparison of at least one of the determined values with the corresponding revenue cycle performance benchmark.

18. The method of claim 17, wherein the database is maintained by a revenue cycle management company.

19. The method of claim 17, wherein each of the revenue cycles of the plurality of other healthcare providers includes the submission of healthcare claims by that healthcare provider to a plurality of healthcare payers, and the receipt of healthcare claim payments and remittance advice from the plurality of healthcare payers in response to the submitted healthcare claims.

20. The method of claim 17, wherein each of the revenue cycle performance benchmarks is a median value of a revenue cycle performance parameter.

B5-B18. (canceled)
